(19) United States
(12) Patent Application Publication
(10) Pub. No.: US 2016/0119569 A1
(43) Pub. Date: Apr. 28, 2016

(54) IMAGE SENSOR AND METHOD OF CONTROLLING THE SAME

(71) Applicant: NANYANG TECHNOLOGICAL UNIVERSITY, Singapore (SG)

(72) Inventors: Shoushun Chen, Singapore (SG); Kay Soon Low, Singapore (SG); Hang Yu, Singapore (SG)

(21) Appl. No.: 14/895,841

(22) PCT Filed: Jul. 2, 2014
(86) PCT No.: PCT/SG2014/000319

§ 371 Date: Dec. 3, 2015

Related U.S. Application Data
(60) Provisional application No. 61/842,535, filed on Jul. 3, 2013.

(51) Int. Cl. H04N 5/374; H04N 5/232

(52) U.S. Cl. CPC H04N 5/3742; H04N 5/23241; H04N 5/23293

(57) ABSTRACT

According to embodiments of the present invention, an image sensor is provided. The image sensor includes a plurality of photodetectors, a plurality of pixel circuits, each pixel circuit including a first transistor, wherein the first transistor is coupled to a respective photodetector of the plurality of photodetectors, and an interconnection bus, wherein, in an imaging mode, the plurality of photodetectors are configured for imaging, and wherein, in a sensing mode, the plurality of photodetectors are configured to detect ambient light condition, and wherein the interconnection bus is connectable between the plurality of pixel circuits and an ambient light readout circuit to carry signals corresponding to the detected ambient light condition from the plurality of photodetectors through the first transistors to the ambient light readout circuit. According to further embodiments, a display including an image sensor and a method of controlling an image sensor are also provided.

### CROSS-REFERENCE TO RELATED APPLICATION

This application claims the benefit of priority of U.S. provisional application No. 61/842,535, filed 3 Jul. 2013, the content of it being hereby incorporated by reference in its entirety for all purposes.

### TECHNICAL FIELD

Various embodiments relate to an image sensor and a method of controlling an image sensor.

### BACKGROUND

There have been significant advancements in the area of portable devices, of which the mobile phone is undoubtedly the most remarkable one. From the black-and-white screen with keyboard to high resolution touchable color screens, mobile phones have become a part of our life. Manufacturers have been paying efforts to improve the users' experience. One aspect is that the light-emitting part can be automatically adjusted against the ambient illumination to suit the users' eyes. On the other hand, the liquid crystal display (LCD) screen and its associated backlighting are among the most power hungry parts in portable devices. A critical design consideration is to save power consumption, hence to provide the user with increased battery life.

Currently, an ambient light sensor (ALS) is employed to detect the ambient illumination condition and generate some control signals. With the ALS's output, the central controller can increase or decrease the display brightness depending on the environment illumination condition. This function has become a norm in the latest devices. For ambient light sensor, technology choices available include photoelectric cells, photodiodes, phototransistors, and photo ICs (integrated circuits). The cost of an ALS is in the range of 0.5˜1 USD.

Another noticeable fact is that, a large number of smart phones are equipped with a front facing camera. It is very important for applications such as video call, video conference or self-imaging. As a result, these phones carry an ALS and a front facing camera at the same time.

### SUMMARY

According to an embodiment, an image sensor is provided. The image sensor may include a plurality of photodetectors, a plurality of pixel circuits, each pixel circuit including a first transistor, wherein the first transistor is coupled to a respective photodetector of the plurality of photodetectors, and an interconnection bus, wherein, in an imaging mode, the plurality of photodetectors are configured for imaging, and wherein, in a sensing mode, the plurality of photodetectors are configured to detect ambient light condition, and wherein the interconnection bus is connectable between the plurality of pixel circuits and an ambient light readout circuit to carry signals corresponding to the detected ambient light condition from the plurality of photodetectors through the first transistors to the ambient light readout circuit.

According to an embodiment, a display is provided. The display may include an image sensor as described herein.

According to an embodiment, a method of controlling an image sensor is provided. The method may include in an imaging mode of an image sensor, imaging a target with a plurality of photodetectors of the image sensor, in a sensing mode of the image sensor, detecting ambient light condition with the plurality of photodetectors, wherein a respective photodetector of the plurality of photodetectors is coupled to a transistor of a respective pixel circuit of the image sensor, and in the sensing mode, connecting an interconnection bus of the image sensor between the pixel circuits and an ambient light readout circuit, such that the interconnection bus carries signals corresponding to the detected ambient light condition from the plurality of photodetectors through the transistors to the ambient light readout circuit.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic view of an image sensor, according to various embodiments.

FIG. 1B shows a flow chart illustrating a method of controlling an image sensor, according to various embodiments.

FIG. 2A shows a schematic view of an image sensor structure.

FIG. 2B shows a schematic view of an image sensor incorporating resistive coupling, according to various embodiments.

FIG. 2C shows a schematic view of an image sensor incorporating capacitive coupling, according to various embodiments.

FIG. 3A shows a schematic view of a structure of a Passive Pixel Sensor (PPS).

FIG. 3B shows a schematic view of a structure of a Passive Pixel Sensor (PPS) incorporating resistive coupling, according to various embodiments.

FIG. 4A shows a schematic view of a structure of a 3-Transistor Active Pixel Sensor (3T APS).

FIG. 4B shows a schematic view of a structure of a 3-Transistor Active Pixel Sensor (3T APS) incorporating resistive coupling, according to various embodiments.

FIG. 4C shows a schematic view of a structure of a 3-Transistor Active Pixel Sensor (3T APS) incorporating capacitive coupling, according to various embodiments.

FIG. 5A shows a schematic view of a structure of a 4-Transistor Active Pixel Sensor (4T APS).

FIG. 5B shows a schematic view of a structure of a 4-Transistor Active Pixel Sensor (4T APS) incorporating resistive coupling, according to various embodiments.

FIG. 5C shows a schematic view of a structure of a 4-Transistor Active Pixel Sensor (4T APS) incorporating capacitive coupling, according to various embodiments.

FIG. 6A shows a schematic view of a structure of a 4-Transistor Anti-Blooming Active Pixel Sensor (4T AB-APS).

FIG. 6B shows a schematic view of a structure of a 4-Transistor Anti-Blooming Active Pixel Sensor (4T AB-APS) incorporating resistive coupling, according to various embodiments.

FIG. 7A shows a schematic view of a structure of a shared 4-Transistor Active Pixel Sensor (shared 4T APS).

FIG. 7B shows a schematic view of a structure of a shared 4-Transistor Active Pixel Sensor (shared 4T APS) incorporating resistive coupling, according to various embodiments.

FIG. 7C shows a schematic view of a structure of a shared 4-Transistor Active Pixel Sensor (shared 4T APS) incorporating capacitive coupling, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide a method to merge an ambient light sensor (ALS) into a CMOS (complementary metal-oxide-semiconductor) image sensor.

Various embodiments relate to a method and a device of integrating an ambient light sensor into a CMOS image sensor, thus enabling the same sensor to work in dual mode. The concept involves incorporating a resistive path or a capacitive path in an existing in-pixel circuit and linking the photo detector and a metal bus. The metal bus has dual purposes: in imaging mode, it delivers power to pixels; while in sensing mode (e.g. ambient light sensing mode), it connects all the photo detectors in the array and carries ambient light signal.

Various embodiments may aim to merge the functionality of ALS (ambient light sensor (ALS)) into a front facing camera (for example of a device, e.g. a smart phone), to further reduce fabrication cost of mobile devices. Currently, the front facing camera is not suitable for this application, mainly due to the following reasons: (1) A camera always comes with a lens. In order to sense the ambient light, i.e. average light in the full field of view (FOV), the CMOS image sensor needs to take a full picture and then perform light averaging. Continuously shooting pictures will consume a lot of power and reduce the battery life; (2) Adding more functionality into the image sensor usually needs additional transistors in the pixel, leading to a larger pixel footprint, and hence increasing the cost of the front facing camera.

In contrast, in various embodiments, the functionality of an ambient light sensor (ALS) may be merged into a CMOS image sensor. Various embodiments may provide one or more of the following features:

(1) The CMOS image sensor may operate in dual modes: an imaging mode, and an ambient light sensing mode. During ambient light sensing, the circuits for imaging readout are in standby mode, and thus do not consume power or consume minimal power. Only the ambient light sensing circuit is working, which consumes very little power, similar to a dedicated ambient light sensor. In other words, the CMOS image sensor may be re-configured into an ambient light sensor, with distributed light detectors. In the imaging mode, the ambient light sensing circuit shuts down, and the sensor falls back to a normal camera.

(2) The method does not need to add more transistors into the pixel. An extra metal bus may be inserted, based on the pixel architecture. The metal bus may be shared by one or more or all the photo detectors, through a configurable dual-mode resistive or capacitive data path. The metal bus may have dual purposes: in the imaging mode, it delivers power to pixels; and in the ambient light sensing mode, it connects all the photo detectors in the array and carries ambient light signal.

Therefore, various embodiments may enable a combination of two types of sensors into one microchip, without increasing the pixel size and power consumption, which are both key factors for today's mobile market. Various embodiments may be applied to any existing CMOS image sensor architecture.

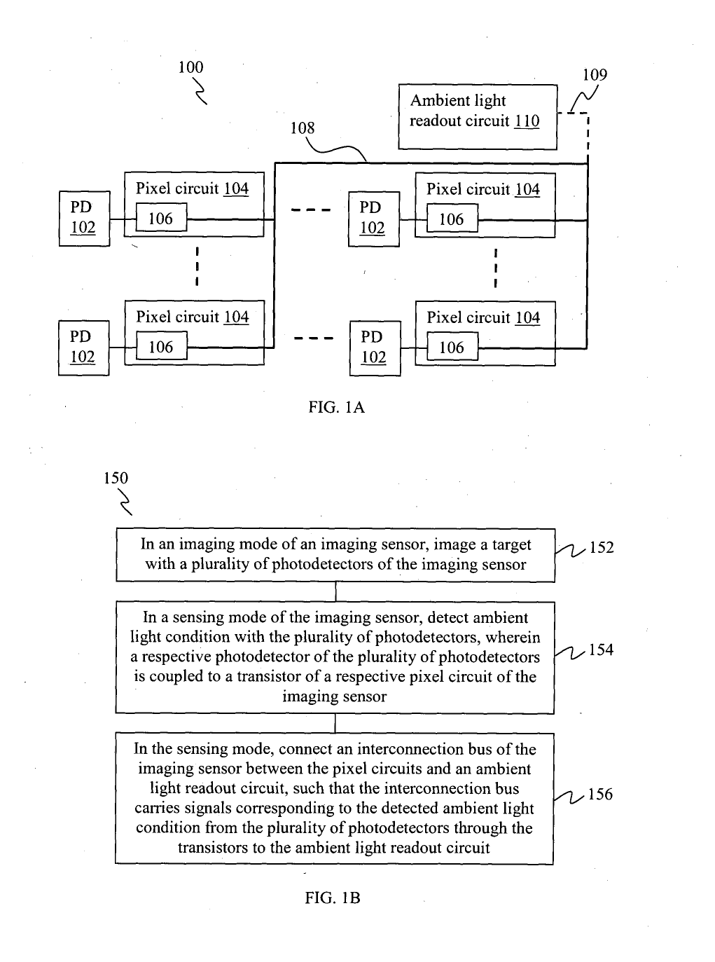

FIG. 1A shows a schematic view of an image sensor 100, according to various embodiments. The image sensor 100 includes a plurality of photodetectors (PDs) 102, a plurality of pixel circuits 104, each pixel circuit 104 including a first transistor 106, wherein the first transistor 106 is coupled to a respective photodetector 102 of the plurality of photodetectors 102, and an interconnection bus 108, wherein, in an imaging mode, the plurality of photodetectors 102 are configured for imaging, and wherein, in a sensing mode, the plurality of photodetectors 102 are configured to detect ambient light condition, and wherein the interconnection bus 108 is connectable (for example as represented by the dashed line 109 to denote a connection) between the plurality of pixel circuits 104 and an ambient light readout circuit 110 to carry signals corresponding to the detected ambient light condition from the plurality of photodetectors 102 through the first transistors 106 to the ambient light readout circuit 110.

In other words, an image sensor 100 having an array of photodetectors (PDs) 102 may be provided. The image sensor 100 may further include a plurality of pixel circuits (e.g. in-pixel supporting circuit) 104. Each pixel circuit 104 may include a first transistor 106 which may be coupled (e.g. mechanically and/or electrically coupled) to a respective photodetector 102. This may mean that each pixel circuit 104 may be coupled to the respective photodetector 102.

The image sensor 100 may further include an interconnection bus 108. The interconnection bus 108 may be connected or connectable to the first transistors 106. Accordingly, the interconnection bus 108 may be connected or connectable to the plurality of pixel circuits 104.

In or during an imaging mode, the plurality of photodetectors 102 may be configured for imaging a target for detecting or capturing image data. In or during a sensing mode, the plurality of photodetectors 102 may be configured to detect ambient light condition (e.g. ambient light amount or level or intensity), and wherein the interconnection bus 108 may be connectable between the plurality of pixel circuits 104 and an ambient light readout circuit 110 to carry or transmit signals (e.g. ambient light signals) corresponding to the detected ambient light condition from the plurality of photodetectors 102 through the first transistors 106 to the ambient light readout circuit 110.

Accordingly, in this way, an ambient light sensor (ALS) may be merged or integrated into an image sensor (e.g. a CMOS image sensor). In other words, the image sensor 100 may work in dual-mode, for imaging and for detecting ambient light.

It should be appreciated that the ambient light readout circuit 110 may or may not form part of the image sensor 100.

In the context of various embodiments, the imaging mode may be a picture/video mode while the sensing mode may be an ambient light sensing mode.

In various embodiments, the interconnection bus 108 may be a common bus to the first transistors 106 and therefore also to the plurality of pixel circuits 104. In other words, the interconnection bus 108 may be shared by the first transistors 106, and therefore also shared by the plurality of photodetectors 102 or all photodetectors 102.

Each photodetector and a corresponding or associated pixel circuit 104 may define a pixel of the image sensor 110. This may mean that the image sensor 100 may include an array of pixels. The array of pixels may be arranged two-dimensionally, for example in n rows and m columns. In other words, the array of pixels may be arranged in a grid-like arrangement.

In various embodiments, the sensing mode may be a non-imaging mode, or in other words, the plurality of photodetectors 102 may be configured to detect ambient light condition during a non-imaging mode of the image sensor 100.

In various embodiments, in the sensing mode, the interconnection bus 108 may be switchably connectable between the plurality of pixel circuits 104 and the ambient light readout circuit 110, or the interconnection bus 108 may be switchably connectable to the ambient light readout circuit 110.

In various embodiments, the plurality of photodetectors 102 may not be configured to detect ambient light condition in the imaging mode.

In various embodiments, each first transistor 106 may provide or define a resistive (R) path or a capacitive (C) path that may link or couple the plurality of photodetectors 102 and the interconnection bus 108.

In the context of various embodiments, each first transistor 106 may be a field-effect transistor (FET).

In the context of various embodiments, the image sensor 100 may be employed or incorporated into a display device or a display of a device. By detecting ambient light condition, brightness of the display may be adjusted depending on the level of ambient light in the environment that the device is exposed to.

In various embodiments, the image sensor 100 may further include the ambient light readout circuit 110. This may mean that the ambient light readout circuit 110 may form part of the image sensor 100, for example integrated with the image sensor 100, such as an on-chip ambient light readout circuit 110.

In the context of various embodiments, the ambient light readout circuit 110 may determine the ambient light intensity corresponding to the detected ambient light condition, for example based on the signals corresponding to the detected ambient light condition.

In various embodiments, the interconnection bus 108 may be switchably connectable to the plurality of pixel circuits 104 to supply power to the plurality of pixel circuits 104 in the imaging mode, and to carry ambient light signals from the plurality of photodetectors 102 to the ambient light readout circuit 110 in the sensing mode. This may mean that the interconnection bus 108 may be switchably connectable to a power supply in the imaging mode to supply power to the plurality of pixel circuits 104, and to the ambient light readout circuit 110 in the sensing mode.

During the imaging mode, the ambient light readout circuit 110 may be deactivated or non-activated (e.g. in an inactive state). In other words, the ambient light readout circuit 110 may shut down. Therefore, the ambient light readout circuit 110 may not consume power or may consume minimal power during the imaging mode.

During the sensing mode, the ambient light readout circuit 110 may be activated (e.g. in an active state).

In the context of various embodiments, the ambient light readout circuit 110 may read out the signals corresponding to the detected ambient light condition as ambient light intensity or may perform processing of the signals corresponding to the detected ambient light condition to determine the ambient light intensity. Examples of processing may include at least one of amplifying the signals or filtering the signals.

In various embodiments, the image sensor 100 may further include a switch, wherein, in the sensing mode, the switch may be configured to connect the interconnection bus 108 to the ambient light readout circuit 110.

In various embodiments, the image sensor 100 may further include an imaging readout circuit, wherein, in the imaging mode, the imaging readout circuit may be configured to receive imaging signals from the plurality of photodetectors 102. The imaging signals may mean the signals generated by the plurality of photodetectors 102 during imaging carried out in the imaging mode. During the imaging mode, the imaging readout circuit may be activated (e.g. in an active state). During the sensing mode, the imaging readout circuit may be deactivated or non-activated (e.g. in an inactive state or in a standby mode). Therefore, the imaging readout circuit may not consume power or may consume minimal power during the sensing mode.

In the context of various embodiments, the imaging readout circuit may perform processing of the imaging signals received. Examples of processing may include at least one of reading out the imaging signals, amplifying the imaging signals, filtering the imaging signals, executing data conversion based on the imaging signals or image processing based on the imaging signals.

In various embodiments, in the imaging mode, the interconnection bus 108 may be adapted or configured to deliver power to the plurality of pixel circuits 104. In this way, the interconnection bus 108 may serve dual purposes, which is to supply or deliver power, in the imaging mode, to the plurality of pixel circuits 104, and therefore to the pixels of the image sensor 100 and, in the sensing mode, to connect to the plurality of photodetectors 102 to carry or transmit the ambient light signals. In various embodiments, the interconnection bus 108 may not be configured to supply power to the plurality of pixel circuits 104 in the sensing mode.

In various embodiments, the image sensor 100 may further include a power source, wherein, in the imaging mode, the interconnection bus 108 may be connectable between the plurality of pixel circuits 104 and the power source to supply power to the plurality of pixel circuits 104. In various embodiments, the interconnection bus 108 may be switchably connectable between the plurality of pixel circuits 104 and the power source or the interconnection bus 108 may be switchably connectable to the power source. In various embodiments, the image sensor 100 may further include another switch, wherein, in the imaging mode, the other switch may be configured to connect the interconnection bus 108 to the power source.

In the context of various embodiments, the switch and the other switch may be activated alternatively to connect the interconnection bus 108 to the ambient light readout circuit 110 or the power supply, depending on the operation mode of the image sensor 100.

In the context of various embodiments, the first transistor 106 may be or may include a select (SEL) transistor. The first transistor 106 may include a first terminal (e.g. a gate (G) terminal) configured to receive a control signal (e.g. SELi), a second terminal (e.g. a first source/drain (S/D1) terminal) coupled to the respective photodetector 102, and a third terminal (e.g. a second source/drain (S/D2) terminal), wherein, in the sensing mode, the interconnection bus 108 may be connectable between the third terminal and the ambient light readout circuit 110. Such a configuration may define a Passive Pixel Sensor (PPS).

In the context of various embodiments, the first transistor 106 may be or may include a reset (RST) transistor. The first transistor 106 may include a first terminal (e.g. a gate (G) terminal) configured to receive a first control signal (e.g. RSTi), a second terminal (e.g. a first source/drain (S/D1) terminal) coupled to the respective photodetector 102, and a third terminal (e.g. a second source/drain (S/D2) terminal), wherein, in the sensing mode, the interconnection bus 108 may be connectable between the third terminal and the ambient light readout circuit 110. In the imaging mode, the interconnection bus 108 may be adapted to supply or deliver power, for example from the power source, to the plurality of pixel circuits 104 and therefore to the pixels of the image sensor 100. In operation, in the sensing mode, all first transistors 106 may be activated to be in an “ON” state. Each first transistor 106 may define a resistive path (e.g. a low impedance resistive path) that may link or couple the respective photodetector 102 and the interconnection bus 108 in the sensing mode, such that the respective photodetector 102 may be coupled to the ambient light readout circuit 110 through the resistive path.

Each pixel circuit 104 may further include a second transistor which may be or may include a source follower (SF) transistor, and a third transistor which may be or may include a selection (RSL) transistor. Each of the second transistor and the third transistor may include a first terminal (e.g. a gate (G) terminal), a second terminal (e.g. a first source/drain (S/D1) terminal), and a third terminal (e.g. a second source/drain (S/D2) terminal). The first terminal of the second transistor may be coupled to the second terminal of the first transistor 106, the third terminal of the second transistor may be configured to receive power, the first terminal of the third transistor may be configured to receive a second control signal (e.g. RSLi), the third terminal of the third transistor may be coupled to a data bus, and the second terminals of the second transistor and the third transistor may be coupled to each other. Such a configuration may define a 3-Transistor Active Pixel Sensor (3T APS) with resistive (R) coupling. In various embodiments, the data bus may carry the imaging signals. The data bus may be coupled to the imaging readout circuit.

Each pixel circuit 104 may further include a fourth transistor which may be or may include a transmission (TX) transistor. The fourth transistor may include a first terminal (e.g. a gate (G) terminal), a second terminal (e.g. a first source/drain (S/D1) terminal), and a third terminal (e.g. a second source/drain (S/D2) terminal). The first terminal of the fourth transistor may be configured to receive a third control signal (e.g. TXi), the third terminal of the fourth transistor may be coupled to the respective photodetector 102, and the second terminal of the first transistor 106, the first terminal of the second transistor and the second terminal of the fourth transistor may be coupled to each other. Such a configuration may define a 4-Transistor Active Pixel Sensor (4T APS) with resistive (R) coupling. In operation, in the sensing mode, all first transistors 106 and all fourth transistors may be activated to be in an “ON” state. Each first transistor 106 and each fourth transistor may define a resistive path (e.g. a low impedance resistive path) that may link or couple the respective photodetector 102 and the interconnection bus 108 in the sensing mode, such that the respective photodetector 102 may be coupled to the ambient light readout circuit 110 through the resistive path.

In various embodiments, the first transistor 106 of each pixel circuit 104 may be coupled to at least two photodetectors 102 of the plurality of photodetectors 102. Each pixel circuit 104 may further include a plurality of fourth transistors. Each fourth transistor may be or may include a transmission (TX) transistor. Each fourth transistor may include a first terminal (e.g. a gate (G) terminal), a second terminal (e.g. a first source/drain (S/D1) terminal), and a third terminal (e.g. a second source/drain (S/D2) terminal). The first terminals of the plurality of fourth transistors may be configured to receive a third control signal (e.g. TXi), the third terminal of a respective fourth transistor of the plurality of fourth transistors may be coupled to a respective photodetector 102 of the at least two photodetectors 102, and the second terminal of the first transistor 106, the first terminal of the second transistor and the second terminals of the plurality of fourth transistors may be coupled to each other. Such a configuration may define a shared 4-Transistor Active Pixel Sensor (shared 4T APS) with resistive (R) coupling. In operation, in the sensing mode, all first transistors 106 and all fourth transistors may be activated to be in an “ON” state. Each first transistor 106 and each fourth transistor may define a resistive path (e.g. a low impedance resistive path) that may link or couple the respective photodetector 102 and the interconnection bus 108 in the sensing mode, such that the respective photodetector 102 may be coupled to the ambient light readout circuit 110 through the resistive path.

In the context of various embodiments, the first transistor 106 may be or may include a source follower (SF) transistor. The first transistor 106 may include a first terminal (e.g. a gate (G) terminal) coupled to the respective photodetector 102, a second terminal (e.g. a first source/drain (S/D1) terminal) coupled to a data bus, and a third terminal (e.g. a second source/drain (S/D2) terminal), wherein, in the sensing mode, the interconnection bus 108 may be connectable between the third terminal and the ambient light readout circuit 110. In various embodiments, the data bus may carry the imaging signals. The data bus may be coupled to the imaging readout circuit. In the imaging mode, the interconnection bus 108 may be adapted to supply or deliver power, for example from the power source, to the plurality of pixel circuits 104 and therefore to the pixels of the image sensor 100.

Each pixel circuit 104 may further include a second transistor which may be or may include a reset (RST) transistor, and a third transistor which may be or may include a selection (RSL) transistor. Each of the second transistor and the third transistor may include a first terminal (e.g. a gate (G) terminal), a second terminal (e.g. a first source/drain (S/D1) terminal), and a third terminal (e.g. a second source/drain (S/D2) terminal). The first terminal of the second transistor may be configured to receive a first control signal (e.g. RSTi), the second terminal of the second transistor may be coupled to the first terminal of the first transistor 106, the third terminal of the second transistor may be configured to receive power, the first terminal of the third transistor may be configured to receive a second control signal (e.g. RSLi), the third terminal of the third transistor may be coupled to the data bus, and the second terminals of the first transistor 106 and the third transistor may be coupled to each other. Such a configuration may define a 3-Transistor Active Pixel Sensor (3T APS) with capacitive (C) coupling. In operation, in the sensing mode, all third transistors may be non-activated to be in an “OFF” state. Each second transistor may be activated to be turned “ON” to reset the respective photodetector 102, and then each second transistor may be deactivated to be turned “OFF”. Thereafter, each respective photodetector 102 may begin exposure to ambient light and the integration charge may be accumulated in the respective photodetector 102. Due to the coupling effect of the gate-drain parasitic capacitor of the first transistor 106, which defines a capacitive path, the voltage of the interconnection bus 108 may follow the average voltage change of all photodetectors 102.

Each pixel circuit 104 may further include a fourth transistor which may be or may include a transmission (TX) transistor. The fourth transistor may include a first terminal (e.g. a gate (G) terminal), a second terminal (e.g. a first source/drain (S/D1) terminal), and a third terminal (e.g. a second source/drain (S/D2) terminal). The first terminal of the fourth transistor may be configured to receive a third control signal (e.g. TXi), the third terminal of the fourth transistor may be coupled to the respective photodetector 102, and the first terminal of the first transistor 106, the second terminal of the second transistor and the second terminal of the fourth transistor may be coupled to each other. Such a configuration may define a 4-Transistor Active Pixel Sensor (4T APS) with capacitive (C) coupling. In operation, in the sensing mode, all third transistors may be non-activated to be in an “OFF” state, and all fourth transistors may be activated to be in an “ON” state. Each second transistor may be activated to be turned “ON” to reset the respective photodetector 102, and then each second transistor may be deactivated to be turned “OFF”. Thereafter, each respective photodetector 102 may begin exposure to ambient light and the integration charge may be accumulated in the respective photodetector 102. Due to the coupling effect of the gate-drain parasitic capacitor of the first transistor 106, which defines a capacitive path, the voltage of the interconnection bus 108 may follow the average voltage change of all photodetectors 102.

In various embodiments, the first transistor 106 of each pixel circuit 104 may be coupled to at least two photodetectors 102 of the plurality of photodetectors 102. Each pixel circuit 104 may further include a plurality of fourth transistors. Each fourth transistor may be or may include a transmission (TX) transistor. Each fourth transistor may include a first terminal (e.g. a gate (G) terminal), a second terminal (e.g. a first source/drain (S/D1) terminal), and a third terminal (e.g. a second source/drain (S/D2) terminal). The first terminals of the plurality of fourth transistors may be configured to receive a third control signal (e.g. TXi), the third terminal of a respective fourth transistor of the plurality of fourth transistors may be coupled to a respective photodetector 102 of the at least two photodetectors 102, and the first terminal of the first transistor 106, the second terminal of the second transistor and the second terminals of the plurality of fourth transistors may be coupled to each other. Such a configuration may define a shared 4-Transistor Active Pixel Sensor (shared 4T APS) with capacitive (C) coupling. In operation, in the sensing mode, all third transistors may be non-activated to be in an “OFF” state, and all fourth transistors may be activated to be in an “ON” state. Each second transistor may be activated to be turned “ON” to reset the respective photodetector 102, and then each second transistor may be deactivated to be turned “OFF”. Thereafter, each respective photodetector 102 may begin exposure to ambient light and the integration charge may be accumulated in the respective photodetector 102. Due to the coupling effect of the gate-drain parasitic capacitor of the first transistor 106, which defines a capacitive path, the voltage of the interconnection bus 108 may follow the average voltage change of all photodetectors 102.

In the context of various embodiments, the first transistor 106 may be or may include an Anti-Blooming (AB) transistor. The first transistor 106 may include a first terminal (e.g. a gate (G) terminal) configured to receive a first control signal (e.g. ABi), a second terminal (e.g. a first source/drain (S/D1) terminal) coupled to the respective photodetector 102, and a third terminal (e.g. a second source/drain (S/D2) terminal), wherein, in the sensing mode, the interconnection bus 108 may be connectable between the third terminal and the ambient light readout circuit 110.

Each pixel circuit 104 may further include a second transistor which may be or may include a transmission (TX) transistor, a third transistor which may be or may include a reset (RST) transistor, a fourth transistor which may be or may include a source follower (SF) transistor, and a fifth transistor which may be or may include a selection (RSL) transistor. Each of the second transistor, the third transistor, the fourth transistor and the fifth transistor may include a first terminal (e.g. a gate (G) terminal), a second terminal (e.g. a first source/drain (S/D1) terminal), and a third terminal (e.g. a second source/drain (S/D2) terminal). The first terminal of the second transistor may be configured to receive a second control signal (e.g. TXi), the second terminal of the first transistor 106 and the third terminal of the second transistor may be coupled to each other, the first terminal of the third transistor may be configured to receive a third control signal (e.g. RSTi), the first terminal of the fifth transistor may be configured to receive a fourth control signal (e.g. RSLi), the third terminal of the fifth transistor may be coupled to a data bus, the second terminal of the second transistor, the second terminal of the third transistor and the first terminal of the fourth transistor may be coupled to each other, the third terminal of the third transistor and the third terminal of the fourth transistor may be configured to receive power, and the second terminals of the fourth transistor and the fifth transistor may be coupled to each other. Such a configuration may define a 4-Transistor Active Pixel Sensor with Anti-Blooming (4T APS-AB) with resistive (R) coupling. In various embodiments, the data bus may carry the imaging signals. The data bus may be coupled to the imaging readout circuit. In the imaging mode, the interconnection bus 108 may be connected to a certain or predetermined potential for anti-blooming purposes. In operation, in the sensing mode, all second transistors may be non-activated to be in an “OFF” state, and all first transistors 106 may be activated to be in an “ON” state. Each first transistor 106 may define a resistive path (e.g. a low impedance resistive path) that may link or couple the respective photodetector 102 and the interconnection bus 108 in the sensing mode, such that the respective photodetector 102 may be coupled to the ambient light readout circuit 110 through the resistive path.

In various embodiments, the image sensor 100 may further include at least one control circuit configured to control operation of the plurality of pixel circuits 104. The at least one control circuit may provide at least one of the control signal, the first control signal, the second control signal, the third control signal, or the fourth control signal. In the context of various embodiments, the at least one control circuit may include for example a row control circuit and/or a column control circuit.

In the context of various embodiments, the interconnection bus 108 may include a metal. The metal may include but not limited to gold (Au), aluminum (Al) or copper (Cu), for example depending on the fabrication technologies.

In the context of various embodiments, in the imaging mode, the ambient light readout circuit 110 may be disconnected from the plurality of pixel circuits 104. For example, this may mean that the ambient light readout circuit 110 may be disconnected from the first transistors 106. Further, the ambient light readout circuit 110 may be deactivated in the imaging mode.

In the context of various embodiments, one or more or each of the transistors in each pixel circuit may be or may include a field-effect transistor (FET).

Various embodiments may also provide a display including the image sensor 100.

In the context of various embodiments, the term “coupled” with regard to two or more components may include direct coupling and/or indirect coupling. For example, two components being coupled to each other may mean that there is a direct coupling path between the two components and/or there is an indirect coupling path between the two components, e.g. via one or more intervening components connected therebetween.

In the context of various embodiments, the term “source/drain terminal” of a transistor may refer to a source terminal or a drain terminal. As the source terminal and the drain terminal of a transistor are generally fabricated such that these terminals are geometrically symmetrical, these terminals may be collectively referred to as source/drain terminals. In various embodiments, a particular source/drain terminal may be a “source” terminal or a “drain” terminal depending on the voltage to be applied to that terminal. Accordingly, the terms “first source/drain terminal” and “second source/drain terminal” may be interchangeable.

FIG. 1B shows a flow chart 150 illustrating a method of controlling an image sensor, according to various embodiments.

At 152, in an imaging mode of an image sensor, a target is imaged with a plurality of photodetectors of the image sensor.

At 154, in a sensing mode of the image sensor, ambient light condition is detected with the plurality of photodetectors, wherein a respective photodetector of the plurality of photodetectors is coupled to a transistor of a respective pixel circuit of the image sensor.

At 156, in the sensing mode, an interconnection bus of the image sensor is connected between the pixel circuits and an ambient light readout circuit, such that the interconnection bus carries signals corresponding to the detected ambient light condition from the plurality of photodetectors through the transistors to the ambient light readout circuit.

In various embodiments, in the imaging mode, power may be supplied or delivered through the interconnection bus to the plurality of pixel circuits.

In various embodiments, ambient light intensity may be determined based on the signals corresponding to the detected ambient light condition. For example, the signals corresponding to the detected ambient light condition may be read out as the ambient light intensity or may be processed to determine the ambient light intensity.

In various embodiments, at least one control signal may be generated to control operation of the plurality of pixel circuits.

In various embodiments, in the imaging mode, the ambient light readout circuit may be deactivated.

In various embodiments, in the imaging mode, the ambient light readout circuit may be disconnected from the plurality of pixel circuits. For example, the ambient light readout circuit may be disconnected from the first transistors.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

Various embodiments may provide or incorporate a method to merge the functionality of an ambient light sensor (ALS) into a CMOS (complementary metal-oxide-semiconductor) image sensor.

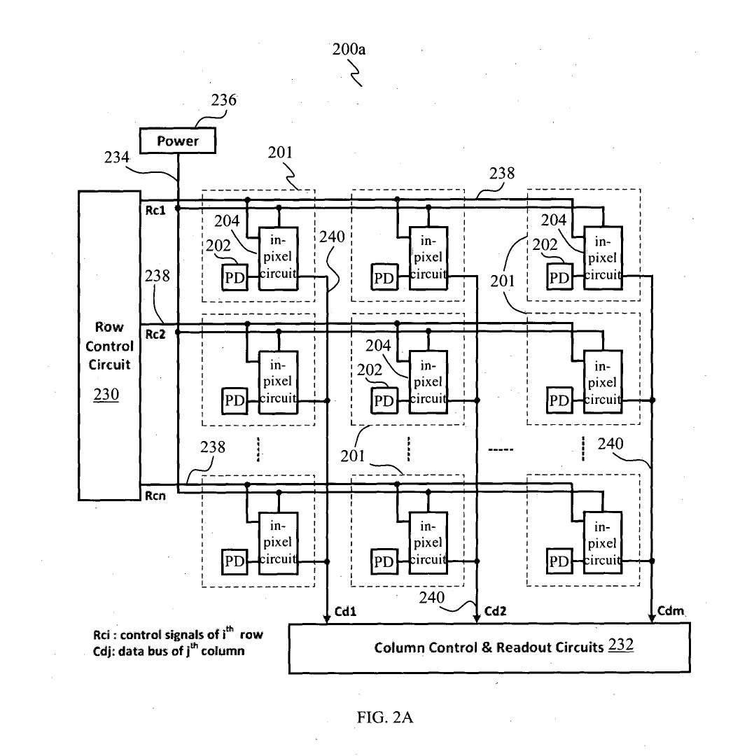

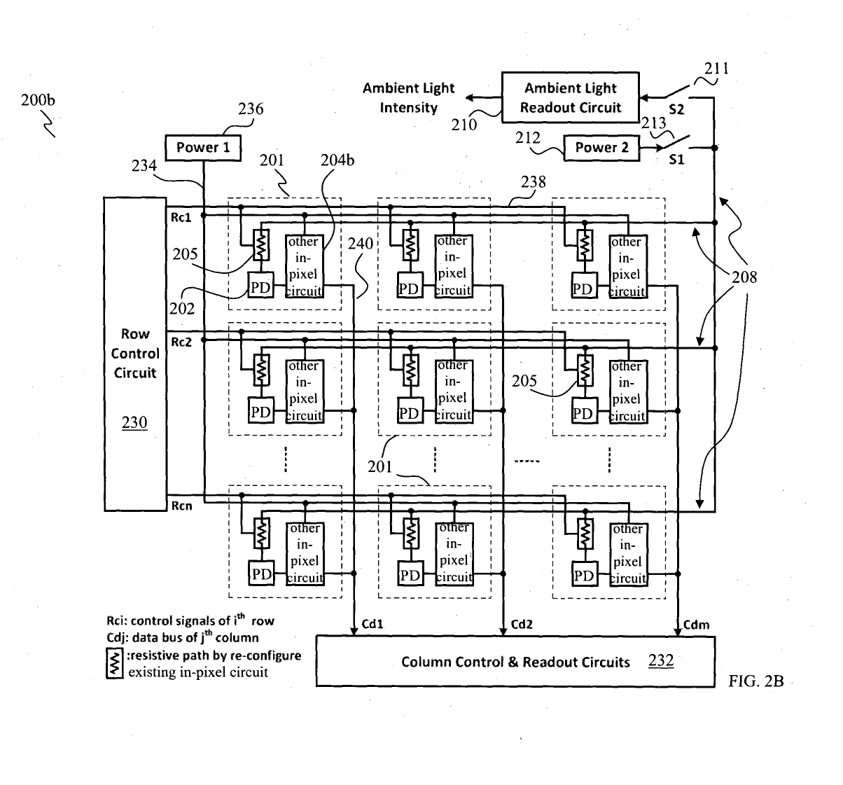

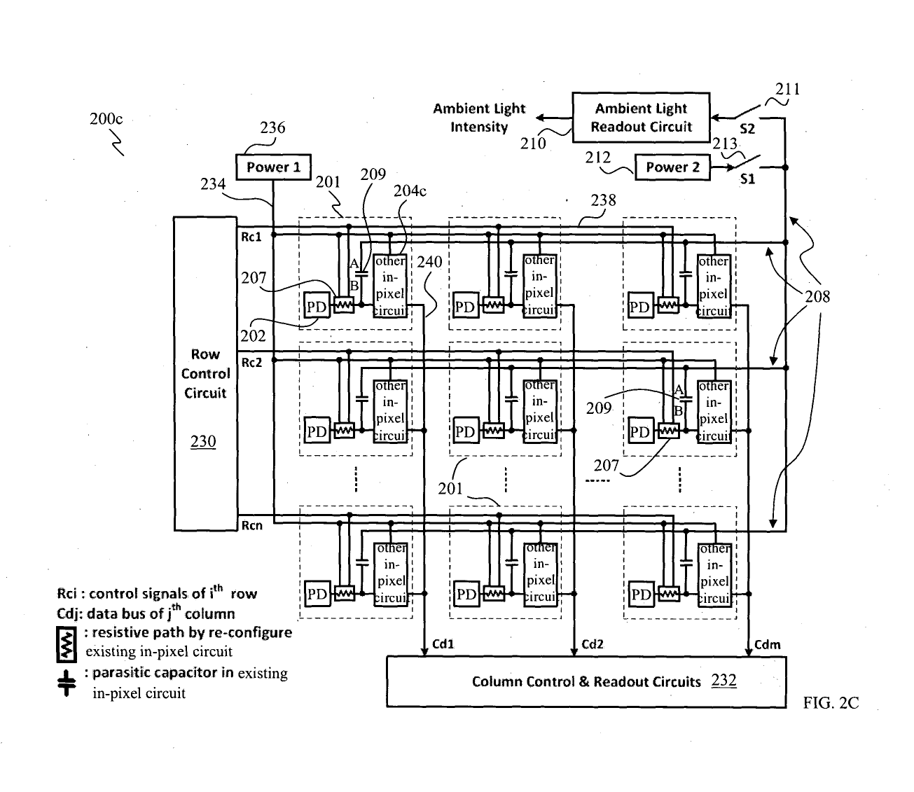

Various embodiments may be applicable to any existing pixel architecture. FIG. 2A shows a schematic view of an image sensor structure (e.g. a CMOS image sensor structure) 200a. The image sensor 200a includes a pixel array, a row controller 230, a column controller and a column readout circuit, which are collectively represented by 232. It should be appreciated that the column controller and the column readout circuit may be integrated within one circuit or provided as separate circuits. The pixel array may be made up by a large number of 2-dimensional placed pixels, as represented by dashed line squares 201, for example arranged in n rows and m columns. Each pixel 201 may include two parts: a photodetector (PD) 202 and an associated in-pixel supporting circuit 204. Various pixel structures may be, employed for each pixel 201, including but not limited to Passive Pixel Sensor (PPS), 3-Transistor Active Pixel Sensor (3T APS), 4-Transistor Active Pixel Sensor (4T APS), and shared 4-Transistor Active Pixel Sensor.

The pixel array may be powered by one or more power buses 234, which may be coupled to a power source 236. The row control circuit 230 may generate row-level signals (e.g. Rci, such as Rc1, Rc2, . . . , Rcn) to control the operations of different pixel row lines 238. The column control and readout circuits 232 may control and select the specified columns or data buses (e.g. Cdj, such as Cd1, Cd2, . . . , Cdm) 240, readout the photo signals from the photodetectors 202 and execute further data conversion or image processing. Usually, the power supply may be designed as an array-level bus; while the row control signals and the column data are planned in row-wise and column-wise, respectively.

In various embodiments, additional transistors may not be necessary or may not be required to be added into the existing pixel architecture. Instead, an extra or additional interconnection bus (e.g. a metal bus) may be inserted. In various embodiments, only the interconnection bus may be added into the pixel architecture.

In various embodiments, the interconnection bus (e.g. a metal bus) may be shared by all the photodetectors (e.g. 202), through a configurable dual-mode resistive data path or capacitive data path. The interconnection bus may serve dual purposes: in an imaging mode, the interconnection bus may deliver power to the pixels (e.g. 201); in a sensing mode (e.g. an ambient light sensing mode), the interconnection bus may connect all the photodetectors (e.g. 202) in the array and carry ambient light signal.

Two implementation methods may be employed in various embodiments. A first example implementation method may incorporate resistive coupling while a second example implementation method may incorporate capacitive coupling. Embodiments employing resistive coupling and capacitive coupling will now be described below with reference to FIGS. 2B and 2C repectively.

FIG. 2B shows a schematic view of an image sensor 200b incorporating resistive coupling, according to various embodiments, illustrating an example of a resistive coupling method to merge an ambient light sensor and a CMOS image sensor. The image sensor 200b may include a pixel array having a plurality of pixels 201, a row controller 230, a column controller and a column readout circuit 232, one or more power buses 234, which may be coupled to a power source 236, a plurality of pixel rows 238, a plurality of data buses 240, which may be as described in the context of the image sensor 200a (FIG. 2A).

Each pixel 201 may include a photodetector (PD) 202 and an associated in-pixel supporting circuit. The symbol [symbol] represents a resistive path 205, which may be defined or made by re-configuring an in-pixel circuit (e.g. 204, FIG. 2A), where the resistive path 205 may link the photodetector 202 and the interconnection bus (e.g. extra metal bus) 208 provided in the image sensor 200b. The resistive path 205 may be defined by one or more transistors which may be provided in the in-pixel circuit. The remaining portion of the in-pixel supporting circuit, without the resistive path 205, is referred to as the “other in-pixel circuit” and represented by 204b.

In the imaging mode, depending on the pixel structure, the resistive path 205 may be used to reset the photodetector voltage or to transfer photo signals from the photodetector 202, and the interconnection bus 208 may deliver power to the pixels 201. For example, the interconnection bus 208 may be connected to a power supply or source, denoted as “Power 2” and represented by 212 in FIG. 2B, via the switch, S1, 213.

In the sensing mode (e.g. ambient light sensing mode), the transistor(s) in the resistive path 205 may be re-configured to be in a constantly ON (e.g. conductive) mode, and thus the resistive path 205 may act as a low impedance link, through which all the photodetectors 202 may be directly attached to the interconnection bus 208, which in turn may be connected to an ambient light readout circuit 210 via the switch, S2, 211. Photo signals generated in all the photodetectors (PDs) 202 may be read-out and processed as the ambient light intensity.

Therefore, as a result, the switch, S2, 211 and the switch, S1, 213 may work alternatively. This may mean that the switch, S1, 213 may be ON (or closed) and the switch, S2, 211 may be OFF (or open) in the imaging mode, while the switch, S2, 211 may be ON (or closed) and the switch, S1, 213 may be OFF (or open) in the ambient light sensing mode.

FIG. 2C shows a schematic view of an image sensor 200c incorporating capacitive coupling, according to various embodiments, illustrating an example of a capacitive coupling method to merge an ambient light sensor and a CMOS image sensor. The image sensor 200c may include a pixel array having a plurality of pixels 201, a row controller 230, a column controller and a column readout circuit 232, one or more power buses 234, which may be coupled to a power source 236, a plurality of pixel rows 238, a plurality of data buses 240, which may be as described in the context of the image sensor 200a (FIG. 2A).

Each pixel 201 may include a photodetector (PD) 202 and an associated in-pixel supporting circuit. The symbol [symbol] represents a parasitic capacitor 209 in an in-pixel circuit (e.g. 204, FIG. 2A). The parasitic capacitor 209 may provide a capacitive coupling path, and may be defined by one, or more transistors which may be provided in the in-pixel circuit. One plate, denoted as “plate A”, of the parasitic capacitor 209 may be connected to the interconnection bus (e.g. extra metal bus) 208, while the other plate, “plate B”, of the parasitic capacitor 209 may be linked to the photodetector (PD) 202 through a resistive path [symbol] 207. The resistive path 207 may be defined or made by re-configuring an in-pixel circuit (e.g. 204, FIG. 2A). The resistive path 207 may be defined by one or more transistors which may be provided in the in-pixel circuit. It should be appreciated that in some embodiments, depending on the pixel structure for example, plate B of the parasitic capacitor 209 may be connected (e.g. directly connected) to the photodetector (PD) 202, without the resistive path 207 in-between. The remaining portion of the in-pixel supporting circuit, without the resistive path 207 and the parasitic capacitor 209, is referred to as the “other in-pixel circuit” and represented by 204c.

In the imaging mode, depending on the pixel structure, the resistive path 207 may be used to reset the photodetector voltage or to transfer photo signals from the photodetector 202, and the interconnection bus 208 may deliver power to the pixels 201. For example, the interconnection bus 208 may be connected to a power supply or source, denoted as “Power 2” and represented by 212 in FIG. 2C, via the switch, S1, 213.

In the sensing mode (e.g. ambient light sensing mode), the transistor(s) in the resistive path 207 may be re-configured to be in a constantly ON (e.g. conductive) mode, and thus may act as a low impedance link, through which plate B of the parasitic capacitor 209 may be directly attached or connected to the photodetector 202. The interconnection bus 208 may be shared with plate A of all the parasitic capacitors 209, where the interconnection bus 208 may be connected to an ambient light readout circuit 210 via the switch, S2, 211. Due to the capacitive coupling effect, the voltage change of the interconnection bus 208 may follow the average voltage change of all the photodetectors (PDs) 202, which may be read-out and processed by the ambient light readout circuit 210.

Therefore, as a result, the switch, S2, 211 and the switch, S1, 213 may work alternatively. This may mean that the switch, S1, 213 may be ON (or closed) and the switch, S2, 211 may be OFF (or open) in the imaging mode, while the switch, S2, 211 may be ON (or closed) and the switch, S1, 213 may be OFF (or open) in the ambient light sensing mode.

As described above, in either of the above implementation method employing resistive coupling or capacitive coupling, only existing devices and parasitic capacitors are employed, and no extra transistors or passive devices are inserted to the pixels. Further, the addition of the interconnection bus 208 only requires a minor change to the pixel layout. Therefore, an ambient light sensor may be easily merged to any existing CMOS image sensor.

Various readout circuits, such as a Corresponded Double Sampling (CDS) (or Correlated Double Sampling) circuit or an Analog-to-Digital Converter (ADC), may be employed as the ambient light readout circuit 210 or incorporated into the ambient light readout circuit 210 to read out and process the ambient photo signals carried through the interconnection bus 208.

For understanding purposes and as non-limiting examples, the aforementioned embodiments may be applied to some CMOS image sensors, e.g. Passive Pixel Sensor (PPS), 3-Transistor Active Pixel Sensor (3T APS), 4-Transistor Active Pixel Sensor (4T APS), 4-Transistor. Active Pixel Sensor with Anti-Blooming and shared 4-Transnsitor Active Pixel Sensor.

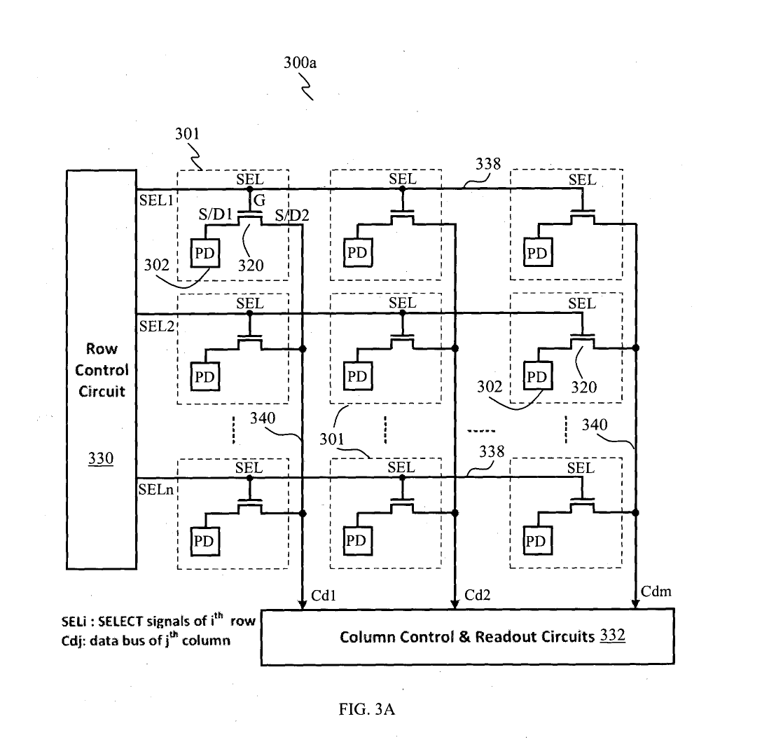

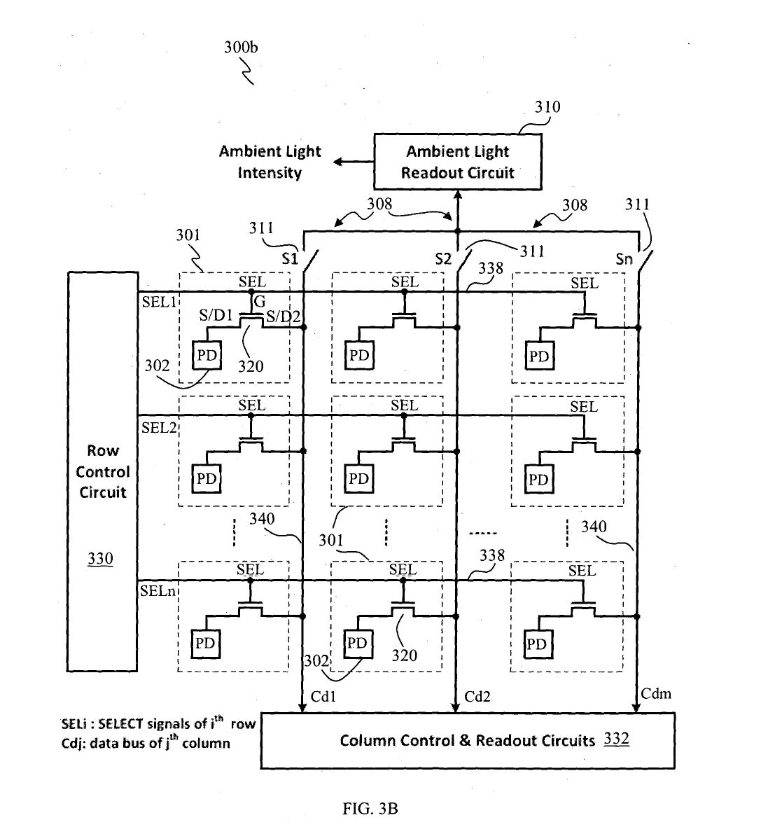

FIG. 3A shows a schematic view of a structure of a Passive Pixel Sensor (PPS) 300a. The image sensor 300a may include a pixel array having a plurality of pixels 301, where each pixel 301 may include a photodetector (PD) 302 and a select (SEL) transistor 320. The select (SEL) transistor 320 may form part of a pixel circuit (or in-pixel circuit). The pixels 301 may be arranged, for example, in n rows and in columns. The image sensor 300a may further include a row control circuit 330, a column control circuit and a column readout circuit, which are collectively represented by 332, a plurality of pixel row lines 338 coupled to the row control circuit 330, and a plurality of data buses 340 coupled to the column control and readout circuits 332, which may be as correspondingly described in the context of the image sensor 200a (FIG. 2A).

Each select (SEL) transistor 320 may include a gate (G) terminal (e.g. a first terminal) coupled to a respective row line 338 to receive a respective control or select signal (e.g. SELi such as SEL1, SEL2, . . . SELn). The respective select signals, SELi, may control operation of the select (SEL) transistors 320. Each select (SEL) transistor 320 may further include a first source/drain (S/D1) terminal (e.g. a second terminal) coupled to a respective photodetector (PD) 302, and a second source/drain (S/D2) terminal (e.g. a third terminal) coupled to a respective data bus (e.g. Cdj, such as Cd1, Cd2, . . . , Cdm) 340.

Using the coupling implementation method of various embodiments, a Passive Pixel Sensor (PPS) may be reused or configured as an ambient light sensor (ALS) by connecting all the column signal data buses (e.g. 340) together, as shown in FIG. 3B.

FIG. 3B shows a schematic view of a structure of a Passive Pixel Sensor (PPS) 300b incorporating resistive coupling, according to various embodiments. Similar or like features may be as described in the context of the Passive Pixel Sensor (PPS) 300a (FIG. 3A). As shown in FIG. 3B, an interconnection bus (e.g. metal bus) 308 may be provided in the image sensor 300b, which may be connected to the data buses 340 via respective switches 311 (e.g. S1, S2, . . . Sn). The interconnection bus 308 may be coupled to an ambient light readout circuit 310. When all the switches, S₁, S₂ . . . Sₙ, 311 are turned OFF (or open), the image sensor 300b may operate in an imaging mode. When the switches S₁, S₂ . . . Sₙ, 311 are turned ON (or closed), in the ambient light sensing mode, the total photo currents may be collected and read-out as the ambient illumination signal. For example, the photo signals from the photodetectors (PDs) 302, corresponding to the detected ambient light condition, may be carried by the interconnection bus 308 to the ambient light readout circuit 310, which may be read-out and/or processed to determine the ambient light intensity. Each select (SEL) transistor 320 may define a resistive path between the associated respective photodetector 302 and the interconnection bus 308.

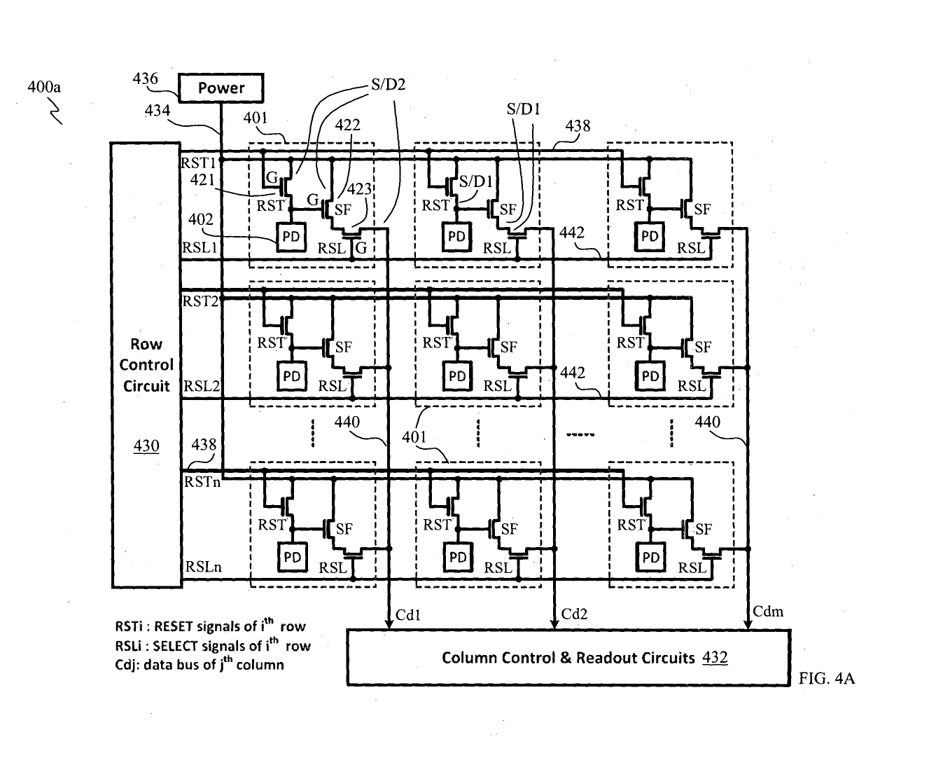

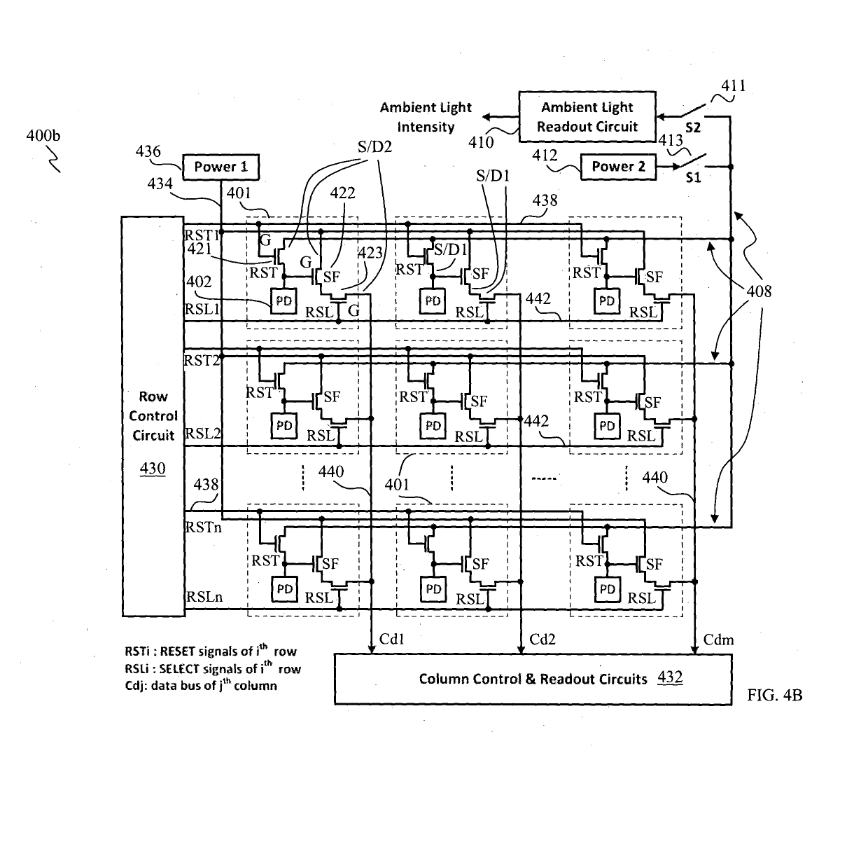

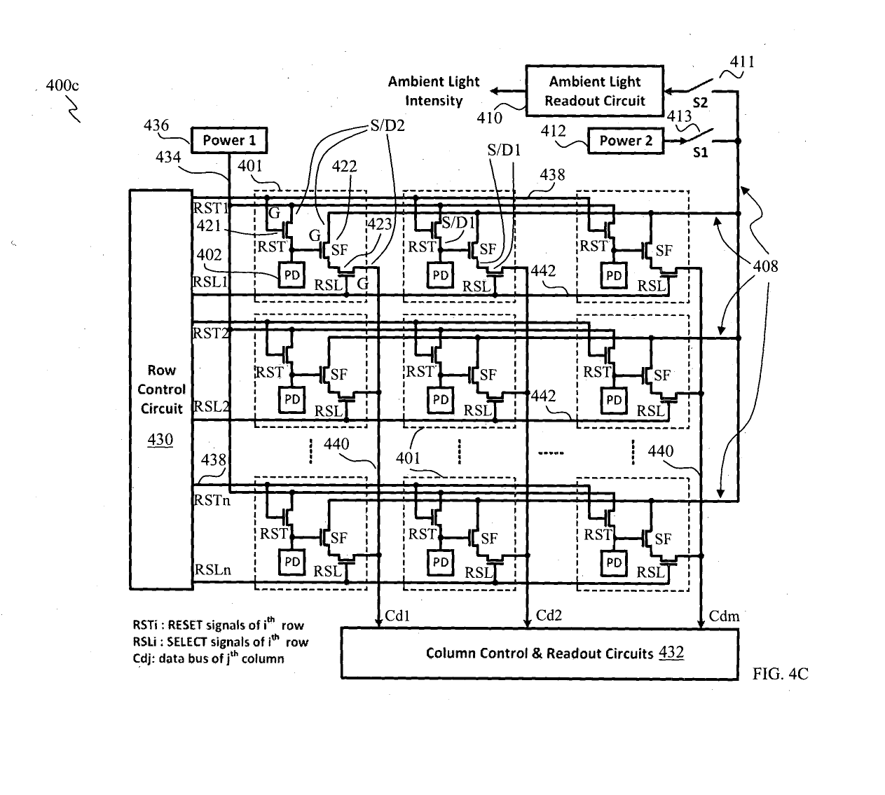

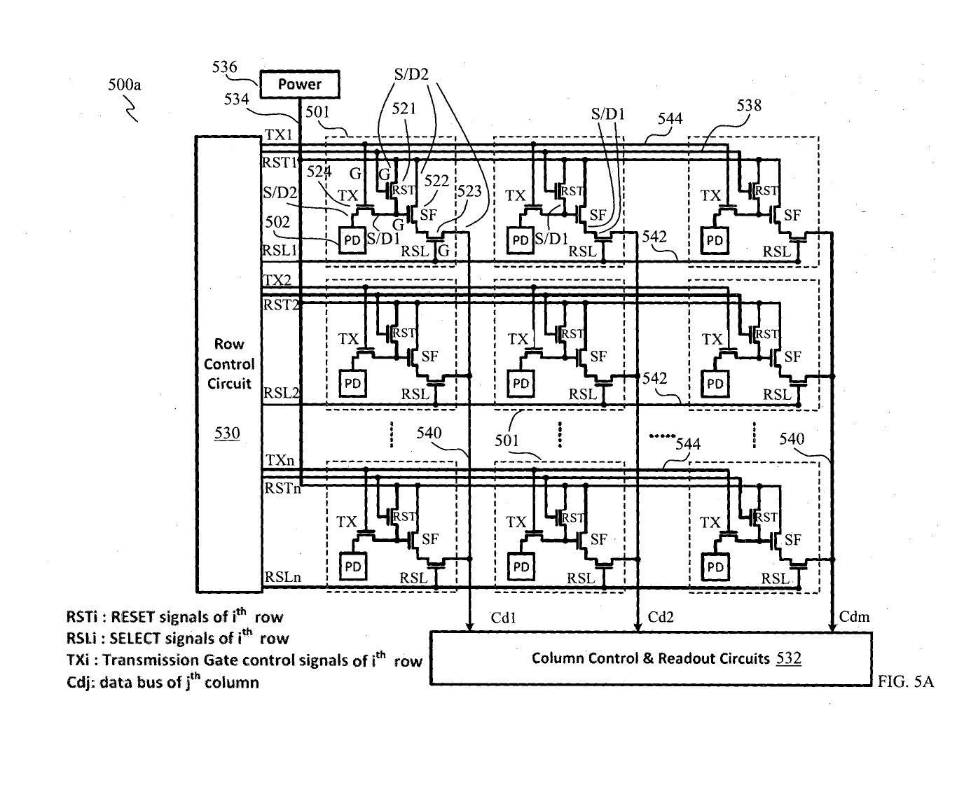

FIG. 4A shows a schematic view of a structure of a 3-Transistor Active Pixel Sensor (3T APS) 400a. The image sensor 400a may include a pixel array having a plurality of pixels 401, where each pixel 401 may include a photo detector (PD) 402, a reset (RST) transistor 421, a source follower (SF) transistor 422 and a selection (RSL) transistor 423. The reset (RST) transistor 421, the source follower (SF) transistor 422 and the selection (RSL) transistor 423 may form part of a pixel circuit (or in-pixel circuit). The pixels 401 may be arranged, for example, in n rows and m columns.

The image sensor 400a may further include a row control circuit 430, a column control circuit and a column readout circuit, which are collectively represented by 432, a plurality of pixel row lines (or reset (RST) row lines) 438 coupled to the row control circuit 430, and a plurality of data buses 440 coupled to the column control and readout circuits 432, one or more power buses 434, which may be coupled to a power source 436, which may be as correspondingly described in the context of the image sensor 200a (FIG. 2A). The image sensor 400a may further include a plurality of second pixel row lines (or select (RSL) row lines) 442 coupled to the row control circuit 430.

Using one pixel 401 as an example, each reset (RST) transistor 421, source follower (SF) transistor 422 and selection (RSL) transistor 423 may include a gate (G) terminal (e.g. a first terminal), a first source/drain (S/D1) terminal (e.g. a second terminal) and a second source/drain (S/D2) terminal (e.g. a third terminal). The gate (G) terminal of the reset (RST) transistor 421 may be coupled to a respective row line 438 to receive a respective control or reset signal (e.g. RSTi, such as RST1, RST2, . . . RSTn). The respective reset signal, RSTi, may control operation of the reset (RST) transistor 421. The gate (G) terminal of the selection (RSL) transistor 423 may be coupled to a respective second row line 442 to receive a respective control or select signal (e.g. RSLi, such as RSL1, RSL2, . . . RSLn). The respective select signal, RSLi, may control operation of the selection (RSL) transistor 423. The gate (G) terminal of the source follower (SF) transistor 422 may be coupled to the first source/drain (S/D1) terminal of the reset (RST) transistor 421 and the photodetector 402. The second source/drain (S/D2) terminals of the reset (RST) transistor 421 and the source follower (SF) transistor 422 may be coupled to the power bus 434. The second source/drain (S/D2) terminal of the selection (RSL) transistor 423 may be coupled to a respective data bus (e.g. Cdj, such as Cd1, Cd2, . . . Cdm) 440. The first source/drain (S/D1) terminals of the source follower (SF) transistor 422 and the selection (RSL) transistor 423 may be coupled to each other.

In the imaging mode, first, the RSL transistor 423 may be turned OFF, the RST transistor 421 may be turned ON to reset/initial the PD 402 to a high voltage for integration/exposure. After the RST transistor 421 is subsequently turned OFF, the PD 402 is electrically floated, and the related integration/exposure may begin. The photo current caused by the input light may discharge the PD 402. After the integration/exposure time, the RSL transistor 423 may be turned ON, and the voltage of the PD 402 may be readout to the column signal data buses 440 through the SF transistor 422, where the SF transistor 422 acts as an amplifier which is to transfer the voltage of the PD 402 out. After the readout process, the RSL transistor 423 may be turned OFF, and the RST transistor 421 may be again turned ON to repeat the above described process.

Using the coupling implementation method of various embodiments, a 3-Transistor Active Pixel Sensor (3T APS) may be reused or configured as an ambient light sensor (ALS), as shown in FIGS. 4B and 4C.

FIG. 4B shows a schematic view of a structure of a 3-Transistor Active Pixel Sensor (3T APS) 400b incorporating resistive coupling, according to various embodiments. The image sensor 400b may be as described in the context of the 3-Transistor Active Pixel Sensor (3T APS) 400a (FIG. 4A), except that the image sensor 400b may further include an interconnection bus 408 that may be coupled to the second source/drain (S/D2) terminals of the reset (RST) transistors 421, an ambient light readout circuit 410, a power source 412, a switch, S2, 411 that may switchably connect the ambient light readout circuit 410 and the interconnection bus 408, and another switch, S1, 413 that may switchably connect the power source 412 and the interconnection bus 408.

For the image sensor 400b incorporating resistive coupling, the reset (RST) transistor 421 may be referred to as a first transistor, the source follower (SF) transistor 422 may be referred to as a second transistor and the selection (RSL) transistor 423 may be referred to as a third transistor.

In the imaging mode, the switch, S1, 413 may be ON (closed) and the switch, S2, 411 may be OFF (open), and the interconnection bus 408 may deliver power to the pixels 401.

In the sensing mode (e.g. ambient light sensing mode), the switch, S1, 413 may be OFF (open) and the switch, S2, 411 may be ON (closed), and all RST transistors 421 may be constantly ON. As a result, all the photodetectors (PDs) 402 may be connected to the ambient light readout circuit 410, via the interconnection bus 408, through a low impedance resistive path defined by or through the respective RST transistor 421.

FIG. 4C shows a schematic view of a structure of a 3-Transistor Active Pixel Sensor (3T APS) 400c incorporating capacitive coupling, according to various embodiments. The image sensor 400c may be as described in the context of the 3-Transistor Active Pixel Sensor (3T APS) 400a (FIG. 4A), except that the image sensor 400c may further include an interconnection bus 408 that may be coupled to the second source/drain (S/D2) terminals of the source follower (SF) transistors 422, an ambient light readout circuit 410, a power source 412, a switch, S2, 411 that may switchably connect the ambient light readout circuit 410 and the interconnection bus 408, and another switch, S1, 413 that may switchably connect the power source 412 and the interconnection bus 408.

For the image sensor 400c incorporating capacitive coupling, the reset (RST) transistor 421 may be referred to as a second transistor, the source follower (SF) transistor 422 may be referred to as a first transistor and the selection (RSL) transistor 423 may be referred to as a third transistor.

In the imaging mode, the switch, S1, 413 may be ON (closed) and the switch, S2, 411 may be OFF (open). The interconnection bus 408 may deliver power to the pixels 401.

In the sensing mode (e.g. ambient light sensing mode), the switch, S1, 413 may be OFF (open) and the switch, S2, 411 may be ON (closed), and all RSL transistors 423 may be constantly OFF. In order to measure ambient light, each RST transistor 421 may be first turned ON to reset the associated photodetector (PD) 402. The RST transistor 421 may then be turned OFF and thereafter, the associated photodetector (PD) 402 may begin exposure, and the integration charge may be accumulated in the photodetector (PD) 402. Due to the coupling effect of the gate-drain (G-D) parasitic capacitor of the SF transistor 422, the voltage of the interconnection bus 408 may follow the average voltage change of all PDs 402.

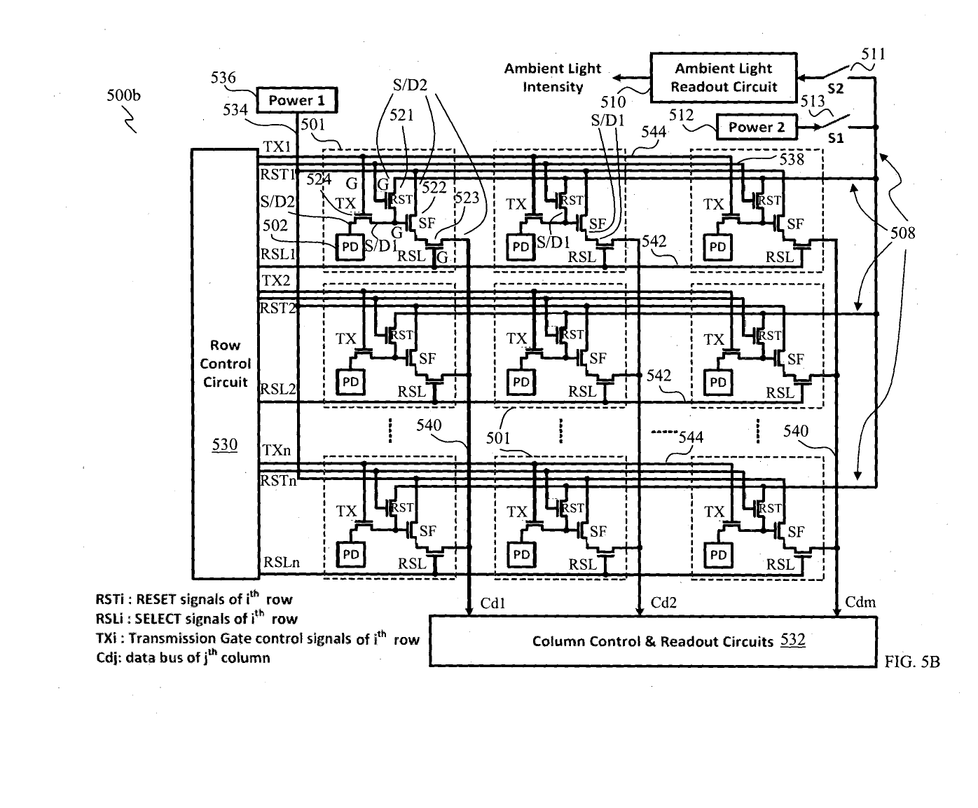

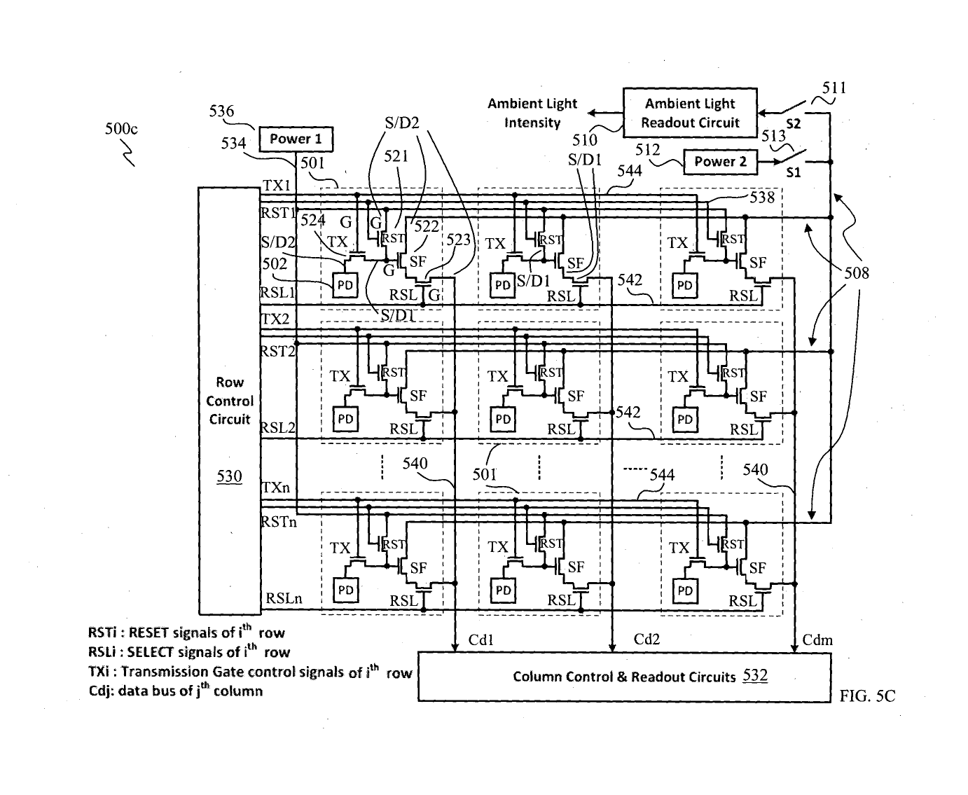

FIG. 5A shows a schematic view of a structure of a 4-Transistor Active Pixel Sensor (4T APS) 500a. The image sensor 500a may include a pixel array having a plurality of pixels 501, where each pixel 501 may include a photo detector (PD) 502, a reset (RST) transistor 521, a source follower (SF) transistor 522 and a selection (RSL) transistor 523 which may be as correspondingly described in the context of the image sensor 400a (FIG. 4A). Each pixel 501 may further include a transmission (TX) transistor 524. The reset (RST) transistor 521, the source follower (SF) transistor 522, the selection (RSL) transistor 523 and the transmission (TX) transistor 524 may form part of a pixel circuit (or in-pixel circuit). The pixels 501 may be arranged, for example, in n rows and m columns.

The image sensor 500a may further include a row control circuit 530, a column control circuit and a column readout circuit, which are collectively represented by 532, a plurality of pixel row lines (or reset (RST) row lines) 538 coupled to the row control circuit 530, and a plurality of data buses 540 coupled to the column control and readout circuits 532, one or more power buses 534, which may be coupled to a power source 536, which may be as correspondingly described in the context of the image sensor 400a (FIG. 4A). The image sensor 500a may further include a plurality of second pixel row lines (or select (RSL) row lines) 542 coupled to the row control circuit 530.

Using one pixel 501 as an example, each reset (RST) transistor 521, source follower (SF) transistor 522, selection (RSL) transistor 523 and TX transistor 524 may include a gate (G) terminal (e.g. a first terminal), a first source/drain (S/D1) terminal (e.g. a second terminal) and a second source/drain (S/D2) terminal (e.g. a third terminal). The gate (G) terminal of the reset (RST) transistor 521 may be coupled to a respective row line 538 to receive a respective control or reset signal (e.g. RSTi, such as RST1, RST2, . . . , RSTn). The respective reset signal, RSTi, may control operation of the reset (RST) transistor 521. The gate (G) terminal of the selection (RSL) transistor 523 may be coupled to a respective second row line 542 to receive a respective control or select signal (e.g. RSLi, such as RSL1, RSL2, . . . RSLn). The respective select signal, RSLi, may control operation of the selection (RSL) transistor 523. The gate (G) terminal of the source follower (SF) transistor 522 may be coupled to the first source/drain (S/D1) terminals of the reset (RST) transistor 521 and the first source/drain (S/D1) terminal of the transmission (TX) transistor 524. The second source/drain (S/D2) terminal of the transmission (TX) transistor 524 may be coupled to the photodetector 502. The gate (G) terminal of the transmission (TX) transistor 524 may be coupled to a respective transmission (TX) row line (or third pixel row line) 544 to receive a respective control signal, for example a transmission gate control signal (e.g. TXi, such as TX1, TX2, . . . , TXn). The respective transmission gate control signal, TXi, may control operation of the transmission (TX) transistor 524. The second source/drain (S/D2) terminals of the reset (RST) transistor 521 and the source follower (SF) transistor 522 may be coupled to the power bus 534. The second source/drain (S/D2) terminal of the selection (RSL) transistor 523 may be coupled to a respective data bus (e.g. Cdj, such as Cd1, Cd2, . . . , Cdm) 540. The first source/drain (S/D1) terminals of the source follower (SF) transistor 522 and the selection (RSL) transistor 523 may be coupled to each other.

In the imaging mode, first, the RSL transistor 523 may be turned OFF, the RST transistor 521 and the TX transistor 524 may be turned ON to reset/initial the PD 502 to a high voltage for integration/exposure. Then, the TX transistor 524 may be turned OFF, and as a result, the PD 502 is electrically floated, and the related integration/exposure may begin. The photo current caused by the input light may discharge the PD 502. After the integration/exposure time, the RSL transistor 523 may be turned ON. The RST transistor 521 may be turned OFF, and the reset voltage may be readout to the column signal data buses 540 through the SF transistor 522, where the SF transistor 522 acts as an amplifier which is to transfer the voltage of the PD 502 out. Then, the TX transistor 524 may be turned ON, and the PD voltage may be readout to the column signal data buses 540. The difference between the reset voltage and the PD voltage is the output signal of the pixel 501. After the readout process, the RSL transistor 523 may be turned OFF, and the RST transistor 521 and the TX transistor 524 may be again turned ON to repeat the above described process.

Using the coupling implementation method of various embodiments, a 4-Transistor Active Pixel Sensor (4T APS) may be reused or configured as an ambient light sensor (ALS), as shown in FIGS. 5B and 5C.

FIG. 5B shows a schematic view of a structure of a 4-Transistor Active Pixel Sensor (4T APS) 500b incorporating resistive coupling, according to various embodiments. The image sensor 500b may be as described in the context of the 4-Transistor Active Pixel Sensor (4T APS) 500a (FIG. 5A), except that the image sensor 500b may further include an interconnection bus 508 that may be coupled to the second source/drain (S/D2) terminals of the reset (RST) transistors 521, an ambient light readout circuit 510, a power source 512, a switch, S2, 511 that may switchably connect the ambient light readout circuit 510 and the interconnection bus 508, and another switch, S1, 513 that may switchably connect the power source 512 and the interconnection bus 508.

For the image sensor 500b incorporating resistive coupling, the reset (RST) transistor 521 may be referred to as a first transistor, the source follower (SF) transistor 522 may be referred to as a second transistor, the selection (RSL) transistor 523 may be referred to as a third transistor and the transmission (TX) transistor 524 may be referred to as a fourth transistor.

In the imaging mode, the switch, S1, 513 may be ON (closed) and the switch, S2, 511 may be OFF (open). The interconnection bus 508 may deliver power to the pixels 501.

In the sensing mode (e.g. ambient light sensing mode), the switch, S1, 513 may be OFF (open) and the switch, S2, 511 may be ON (closed), and all RST transistors 521 and TX transistors 524 may be constantly ON. As a result, all the photodetectors (PDs) 502 may be connected to the ambient light readout circuit 510, via the interconnection bus 508, through a low impedance resistive path defined by or through the respective TX transistor 524 and RST transistor 521.

FIG. 5C shows a schematic view of a structure of a 4-Transistor Active Pixel Sensor (4T APS) 500c incorporating capacitive coupling, according to various embodiments. The image sensor 500c may be as described in the context of the 4-Transistor Active Pixel Sensor (4T APS) 500a (FIG. 5A), except that the image sensor 500c may further include an interconnection bus 508 that may be coupled to the second source/drain (S/D2) terminals of the source follower (SF) transistors 522, an ambient light readout circuit 510, a power source 512, a switch, S2, 511 that may switchably connect the ambient light readout circuit 510 and the interconnection bus 508, and another switch, S1, 513 that may switchably connect the power source 512 and the interconnection bus 508.

For the image sensor 500c incorporating capacitive coupling, the reset (RST) transistor 521 may be referred to as a second transistor, the source follower (SF) transistor 522 may be referred to as a first transistor, the selection (RSL) transistor 423 may be referred to as a third transistor, and the transmission (TX) transistor 524 may be referred to as a fourth transistor.

In the imaging mode, the switch, S1, 513 may be ON (closed) and the switch, S2, 511 may be OFF (open). The interconnection bus 508 may deliver power to the pixels 501.

In the sensing mode (e.g. ambient light sensing mode), the switch, S1, 513 may be OFF (open) and the switch, S2, 511 may be ON (closed), and all RSL transistors 523 may be constantly OFF and all TX transistors 524 may be constantly ON. In order to measure ambient light, each RST transistor 521 may be first turned ON to reset the associated photodetector (PD) 502. The RST transistor 521 may then be turned OFF and thereafter, the associated photodetector (PD) 502 may begin exposure, and the integration charge may be accumulated in the photodetector (PD) 502. Due to the coupling effect of the gate-drain (G-D) parasitic capacitor of the SF transistor 522, the voltage of the interconnection bus 508 may follow the average voltage change of all PDs 502.

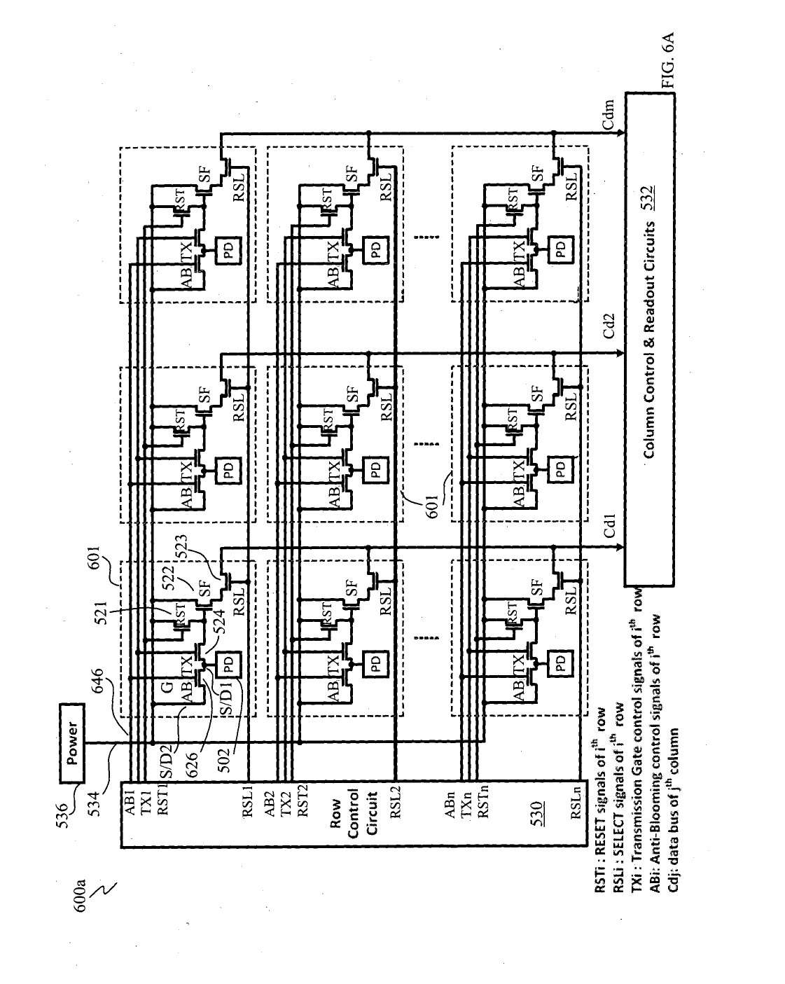

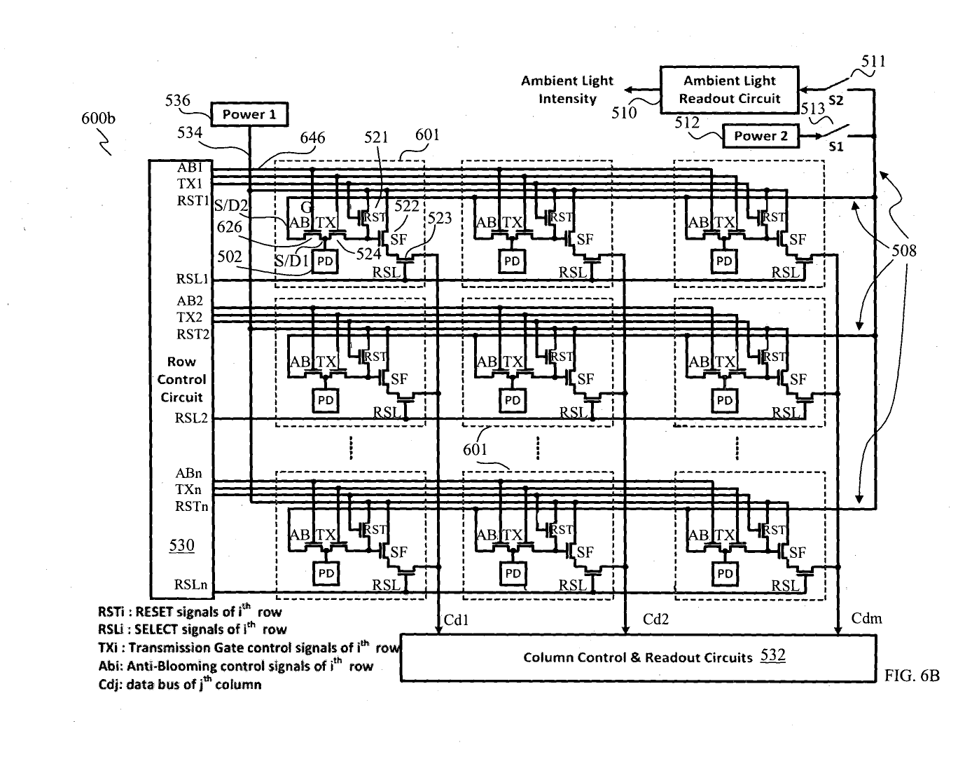

In various designs, an Anti-Blooming (AB) transistor may be added into a 4-Transistor Active Pixel Sensor, as shown in FIG. 6A. FIG. 6A shows a schematic view of a structure of a 4-Transistor Anti-Blooming Active Pixel Sensor (4T AB-APS) 600a. The image sensor 600a may include a pixel array having a plurality of pixels 601, where each pixel 601 may include a photo detector (PD) 502, a reset (RST) transistor 521, a source follower (SF) transistor 522, a selection (RSL) transistor 523, and a transmission (TX) transistor 524 which may be as correspondingly described in the context of the image sensor 500a (FIG. 5A). Each pixel 601 may further include an Anti-Blooming (AB) transistor 626. The reset (RST) transistor 521, the source follower (SF) transistor 522, the selection (RSL) transistor 523, the transmission (TX) transistor 524 and the Anti-Blooming (AB) transistor 626 may form part of a pixel circuit (or in-pixel circuit). The pixels 601 may be arranged, for example, in n rows and m columns. Further, other components of the image sensor 600a may be as described in the context of the image sensor 500a (FIG. 5A). For the 4T-APS, if the input light is very strong, during the integration/exposure, the PD 502 may have a big voltage drop, which may cause negative effects to the neighboring pixels 601. So an Anti-Blooming (AB) transistor 626 may be added, where if the input light is very strong, the Anti-Blooming (AB) transistor 626 may be partially turned ON to prevent the PD voltage from dropping too much. This may prevent or at least minimise any adverse effects on neighboring pixels 601.

Using one pixel 601 as an example, connections of the respective terminals of the reset (RST) transistor 521, source follower (SF) transistor 522, selection (RSL) transistor 523, and transmission (TX) transistor 524 may be as described in the context of the image sensor 500a (FIG. 5A). Further, the gate (G) terminal of the Anti-Blooming (AB) transistor 626 may be coupled to a respective anti-blooming (AB) row line (or fourth pixel row line) 646 to receive a respective control signal, for example an anti-blooming control signal (e.g. ABi, such as AB1, AB2, . . . ABn). The respective anti-blooming control signal, ABi, may control operation of the Anti-Blooming (AB) transistor 626. The first source/drain (S/D1) terminal of the Anti-Blooming (AB) transistor 626 may be coupled to the photodetector 502 and the second source/drain (S/D2) terminal of the transmission (TX) transistor 524. The second source/drain (S/D2) terminal of the Anti-Blooming (AB) transistor 626 may be coupled to the power bus 534.

Using the coupling implementation method of various embodiments, a 4-Transistor Anti-Blooming Active Pixel Sensor (4T AB-APS) may be reused or configured as an ambient light sensor (ALS), as shown in FIG. 6B.

FIG. 6B shows a schematic view of a structure of a 4-Transistor Anti-Blooming Active Pixel Sensor (4T AB-APS) 600b incorporating resistive coupling, according to various embodiments. The image sensor 600b may be as described in the context of the 4-Transistor Anti-Blooming Active Pixel Sensor (4T AB-APS) 600a (FIG. 6A), except that the image sensor 600b may further include an interconnection bus 508 that may be coupled to the second source/drain (S/D2) terminals of the Anti-Blooming (AB) transistors 626, an ambient light readout circuit 510, a power source 512, a switch, S2, 511 that may switchably connect the ambient light readout circuit 510 and the interconnection bus 508, and another switch, S1, 513 that may switchably connect the power source 512 and the interconnection bus 508.

For the image sensor 600b incorporating resistive coupling, the Anti-Blooming (AB) transistor 626 may be referred to as a first transistor, the transmission (TX) transistor 524 may be referred to as a second transistor, the reset (RST) transistor 521 may be referred to as a third transistor, the source follower (SF) transistor 522 may be referred to as a fourth transistor and the selection (RSL) transistor 523 may be referred to as a fifth transistor.

In the imaging mode, the switch, S1, 513 may be ON (closed) and the switch, S2, 511 may be OFF (open). The interconnection bus 508 may be connected to a certain potential or voltage for anti-blooming purpose.

In the sensing mode (e.g. ambient light sensing mode), the switch, S1, 513 may be OFF (open) and the switch, S2, 511 may be ON (closed), and all TX transistors 524 may be constantly OFF and all Anti-Blooming (AB) transistor 626 may be constantly ON. As a result, all the photodetectors (PDs) 502 may be connected to the ambient light readout circuit 510, via the interconnection bus 508, through a low impedance resistive path defined by or through the respective Anti-Blooming (AB) transistor 626.

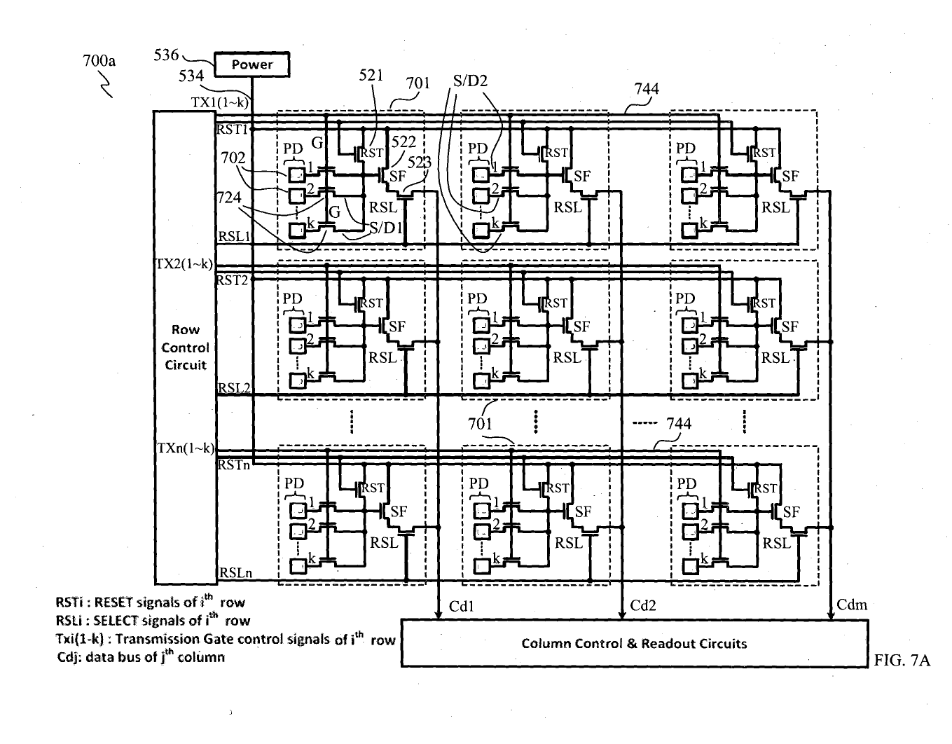

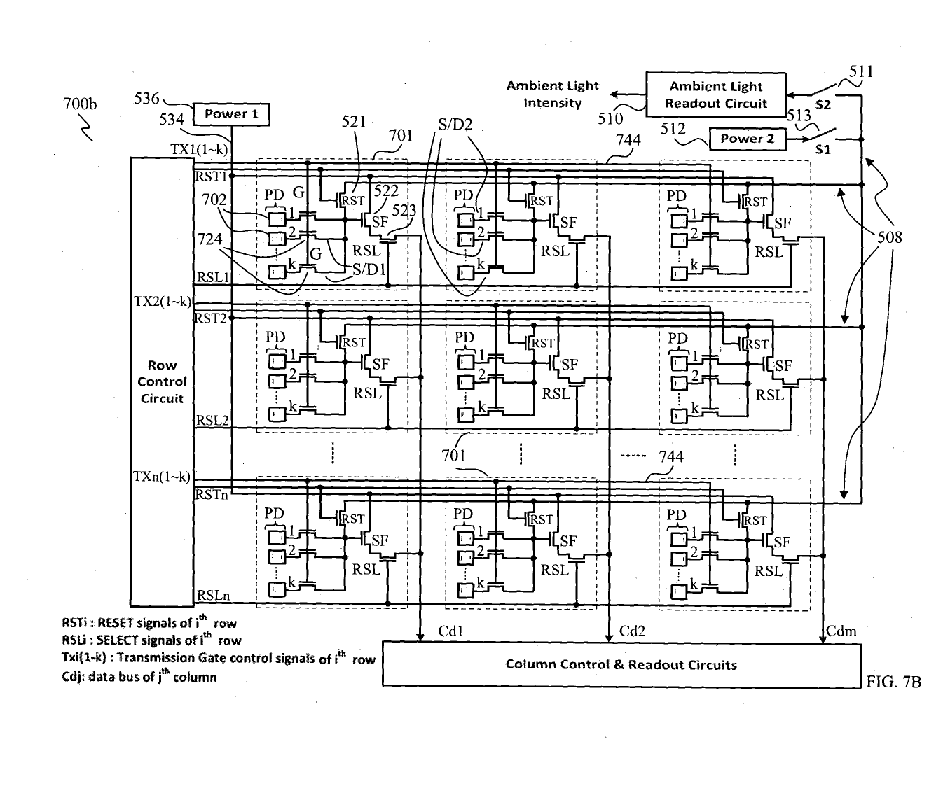

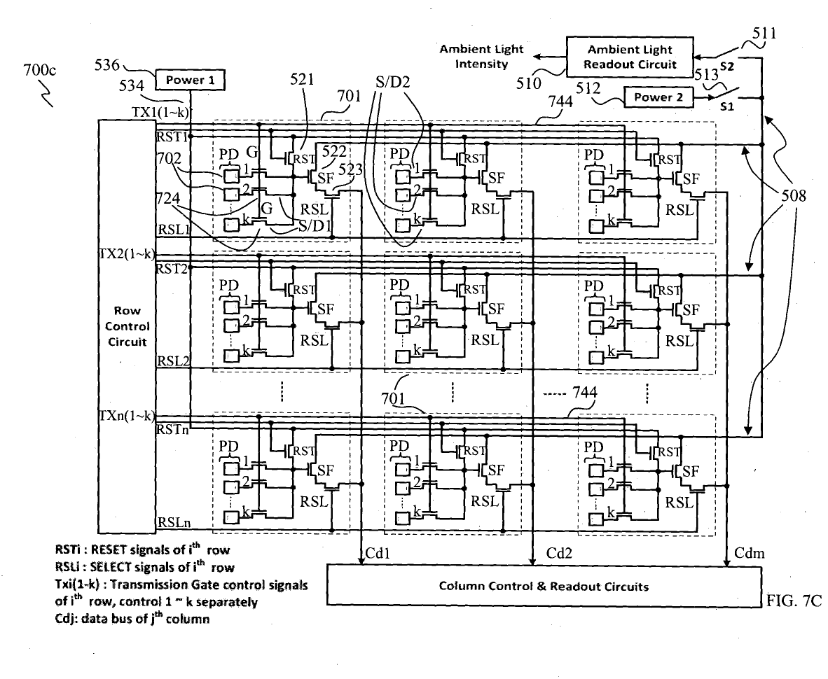

In order to increase the fill factor, a structure may be provided, which is to share the RST, SF and/or SEL transistors between pixels, as shown in FIG. 7A. FIG. 7A shows a schematic view of a structure of a shared 4-Transistor Active Pixel Sensor (shared 4T APS) 700a. The image sensor 700a may include a pixel array having a plurality of pixel arrangements 701, where each pixel arrangement 701 may include a reset (RST) transistor 521, a source follower (SF) transistor 522, and a selection (RSL) transistor 523 which may be as correspondingly described in the context of the image sensor 500a (FIG. 5A). Each pixel arrangement 701 may further include a plurality of transmission (TX) transistors 724 coupled to respective photodetectors (PDs) 702, where each transmission (TX) transistor 724 and each photodetector. (PD) 702 may be as correspondingly described in the context of the image sensor 500a (FIG. 5A). The reset (RST) transistor 521, the source follower (SF) transistor 522 and the selection (RSL) transistor 523 may form part of a pixel circuit (or in-pixel circuit). The pixels arrangements 701 may be arranged, for example, in n rows and m columns. Further, other components of the image sensor 700a may be as described in the context of the image sensor 500a (FIG. 5A).

Using one pixel arrangement 701 as an example, connections of the respective terminals of the reset (RST) transistor 521, source follower (SF) transistor 522, and selection (RSL) transistor 523 and each transmission (TX) transistor 524 may be as described in the context of the image sensor 500a (FIG. 5A). The respective gate (G) terminals of the transmission (TX) transistors 724 may be coupled to a respective transmission (TX) row line (or third pixel row line) 744 to receive a respective control signal, for example a transmission gate control signal (e.g. TXi (1-k), such as TX1 (1-k), TX2 (1-k), . . . TXn (1-k)). The respective transmission gate control signal, TXi (1-k), may control operation of the transmission (TX) transistors 724. Each transmission (TX) transistor 724 of each pixel arrangement 701 may be separately controlled. The respective first source/drain (S/D1) terminals of the transmission (TX) transistors 724 may be coupled to the gate (G) terminal of the source follower (SF) transistor 522 and the first source/drain (S/D1) terminal of the reset (RST) transistor 521. The respective second source/drain (S/D2) terminals of the transmission (TX) transistors 724 may be coupled to a respective photodetector 702.

Using the coupling implementation method of various embodiments, a shared 4-Transistor Active Pixel Sensor (shared 4T APS) may be reused or configured as an ambient light sensor (ALS), as shown in FIGS. 7B and 7C.

FIG. 7B shows a schematic view of a structure of a shared 4-Transistor Active Pixel Sensor (shared 4T APS) 700b incorporating resistive coupling, according to various embodiments. The image sensor 700b may be as described in the context of the shared 4-Transistor Active Pixel Sensor (shared 4T APS) 700a (FIG. 7A), except that the image sensor 700b may further include an interconnection bus 508 that may be coupled to the second source/drain (S/D2) terminals of the reset (RST) transistors 521, an ambient light readout circuit 510, a power source 512, a switch, S2, 511 that may switchably connect the ambient light readout circuit 510 and the interconnection bus 508, and another switch, S1, 513 that may switchably connect the power source 512 and the interconnection bus 508.

For the image sensor 700b incorporating resistive coupling, the reset (RST) transistor 521 may be referred to as a first transistor, the source follower (SF) transistor 522 may be referred to as a second transistor, the selection (RSL) transistor 523 may be referred to as a third transistor and each transmission (TX) transistor 724 may be referred to as a fourth transistor.

In the imaging mode, the switch, S1, 513 may be ON (closed) and the switch, S2, 511 may be OFF (open). The interconnection bus 508 may deliver power to the pixel arrangements 701.

In the sensing mode (e.g. ambient light sensing mode), the switch, S1, 513 may be OFF (open) and the switch, S2, 511 may be ON (closed), and all RST transistors 521 and TX transistors 724 may be constantly ON. As a result, all the photodetectors (PDs) 702 may be connected to the ambient light readout circuit 510, via the interconnection bus 508, through a low impedance resistive path defined by or through the respective TX transistor 724 and RST transistor 521.

FIG. 7C shows a schematic view of a structure of a shared 4-Transistor Active Pixel Sensor (shared 4T APS) 700c incorporating capacitive coupling, according to various embodiments. The image sensor 700c may be as described in the context of the shared 4-Transistor Active Pixel Sensor (shared 4T APS) 700a (FIG. 7A), except that the image sensor 700c may further include an interconnection bus 508 that may be coupled to the second source/drain (S/D2) terminals of the source follower (SF) transistors 522, an ambient light readout circuit 510, a power source 512, a switch, S2, 511 that may switchably connect the ambient light readout circuit 510 and the interconnection bus 508, and another switch, S1, 513 that may switchably connect the power source 512 and the interconnection bus 508.

For the image sensor 700c incorporating capacitive coupling, the reset (RST) transistor 521 may be referred to as a second transistor, the source follower (SF) transistor 522 may be referred to as a first transistor, the selection (RSL) transistor 423 may be referred to as a third transistor, and each transmission (TX) transistor 724 may be referred to as a fourth transistor.

In the imaging mode, the switch, S1, 513 may be ON (closed) and the switch, S2, 511 may be OFF (open). The interconnection bus 508 may deliver power to the pixel arrangements 701.

In the sensing mode (e.g. ambient light sensing mode), the switch, S1, 513 may be OFF (open) and the switch, S2, 511 may be ON (closed), and all RSL transistors 523 may be constantly OFF and all TX transistors 724 may be constantly ON. In order to measure ambient light, each RST transistor 521 may be first turned ON to reset the photodetectors (PDs) 702. The RST transistor 521 may then be turned OFF and thereafter, the photodetectors (PDs) 702 may begin exposure. Integration charge may be accumulated in the photodetectors (PDs) 702. Due to the coupling effect of the gate-drain (G-D) parasitic capacitor of the SF transistor 522, the voltage of the interconnection bus 508 may follow the average voltage change of all PDs 702.

As described above, various embodiments may provide an approach to reuse a pixel array as an ambient light sensor with one or more of the following features:

(1) Various embodiments may be applied in an existing CMOS image sensor. and which may not require adding transistors into the pixel.

(2) A CMOS image sensor may be configured into either of two working modes: imaging mode, and sensing mode (e.g. ambient light sensing mode).

(3) A dual-purpose metal bus may be inserted into the pixel array. In ambient light sensing mode, by configuring the existing in-pixel circuits, the metal bus may be shared by all the photodetectors through a resistive data path or a capacitive data path. As such, the metal bus carries the average ambient light signal of the whole pixel array. In imaging mode, the bus may deliver power to the pixels, and the data path between the metal bus and the photo detectors may fall back to a conventional configuration.

Further, various embodiments may enable a combination or integration of an ambient light sensor and a CMOS image sensor, without increasing pixel size and power consumption, which are both key factors for today's mobile device market. In this way, the functions of an ambient light sensor and a CMOS image sensor may be integrated into one sensor architecture. Various embodiments may be applied to any existing CMOS image sensor architecture. As such, the ambient light sensor, which may be required for a conventional device, may be removed and the fabrication cost of mobile devices may be further reduced. In other words, a separate ambient light sensor may not be required. Considering the huge global market of smart phones, tablets and laptops, various embodiments may have a great potential of applications.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An image sensor comprising:
a plurality of photodetectors;
a plurality of pixel circuits, each pixel circuit comprising a first transistor and at least one additional transistor coupled to each other, wherein the first transistor is coupled to a respective photodetector of the plurality of photodetectors;
an interconnection bus connected to the first transistors of the plurality of pixel circuits; and p1 a power bus connected to the at least one additional transistors of the plurality of pixel circuits, and adapted to deliver power to the at least one additional transistors, the power bus being separate from the interconnection bus,
wherein, in an imaging mode, the plurality of photodetectors are configured for imaging, and
wherein, in a sensing mode, the plurality of photodetectors are configured to detect ambient light condition, and wherein the interconnection bus is connectable between the plurality of pixel circuits and an ambient light readout circuit to carry signals corresponding to the detected ambient light condition from the plurality of photodetectors through the first transistors to the ambient light readout circuit.

2. The image sensor as claimed in claim 1, further comprising the ambient light readout circuit.

3. The image sensor as claimed in claim 1, further comprising a switch, wherein, in the sensing mode, the switch is configured to connect the interconnection bus to the ambient light readout circuit.

4. The image sensor as claimed in claim 1, further comprising an imaging readout circuit, wherein, in the imaging mode, the imaging readout circuit is configured to receive imaging signals from the plurality of photodetectors.

5. The image sensor as claimed in claim 1, wherein, in the imaging mode, the interconnection bus is adapted to deliver power to the first transistors of the plurality of pixel circuits.

6. The image sensor as claimed in claim 5, further comprising a power source,
wherein, in the imaging mode, the interconnection bus is connectable between the plurality of pixel circuits and the power source to supply power to the first transistors of the plurality of pixel circuits.

7. The image sensor as claimed in claim 6, further comprising another switch, wherein, in the imaging mode, the other switch is configured to connect the interconnection bus to the power source.

8. (canceled)

9. The image sensor as claimed in claim 1, wherein the first transistor comprises:
a first terminal configured to receive a first control signal;
a second terminal coupled to the respective photodetector; and
a third terminal, wherein, in the sensing mode, the interconnection bus is connectable between the third terminal and the ambient light readout circuit.

10. The image sensor as claimed in claim 9, wherein the at least one additional transistor of each pixel circuit further comprises:
a second transistor; and
a third transistor,
wherein each of the second transistor and the third transistor comprises:
a first terminal;
a second terminal; and
a third terminal,
wherein the first terminal of the second transistor is coupled to the second terminal of the first transistor,
wherein the third terminal of the second transistor is configured to receive power,
wherein the first terminal of the third transistor is configured to receive a second control signal,
wherein the third terminal of the third transistor is coupled to a data bus, and
wherein the second terminals of the second transistor and the third transistor are coupled to each other.

11. The image sensor as claimed in claim 10, wherein the at least one additional transistor of each pixel circuit further comprises:
a fourth transistor comprising a first terminal, a second terminal and a third terminal,
wherein the first terminal of the fourth transistor is configured to receive a third control signal,
wherein the third terminal of the fourth transistor is coupled to the respective photodetector, and
wherein the second terminal of the first transistor, the first terminal of the second transistor and the second terminal of the fourth transistor are coupled to each other.

12. The image sensor as claimed in claim 9, wherein the first transistor of each pixel circuit is coupled to at least two photodetectors of the plurality of photodetectors.

13. The image sensor as claimed in claim 12, wherein the at least one additional transistor of each pixel circuit comprises:
a plurality of fourth transistors, each fourth transistor comprising a first terminal, a second terminal and a third terminal,
wherein the first terminals of the plurality of fourth transistors are configured to receive a third control signal,
wherein the third terminal of a respective fourth transistor of the plurality of fourth transistors is coupled to a respective photodetector of the at least two photodetectors, and
wherein the second terminal of the first transistor, the first terminal of the second transistor and the second terminals of the plurality of fourth transistors are coupled to each other.

14. The image sensor as claimed in claim 1, wherein the first transistor comprises:
a first terminal coupled to the respective photodetector;
a second terminal coupled to a data bus; and
a third terminal, wherein, in the sensing mode, the interconnection bus is connectable between the third terminal and the ambient light readout circuit.

15. The image sensor as claimed in claim 14, wherein the at least one additional transistor of each pixel circuit further comprises:
a second transistor; and
a third transistor,
wherein each of the second transistor and the third transistor comprises:
a first terminal;
a second terminal; and
a third terminal,
wherein the first terminal of the second transistor is configured to receive a first control signal,
wherein the second terminal of the second transistor is coupled to the first terminal of the first transistor,
wherein the third terminal of the second transistor is configured to receive power,
wherein the first terminal of the third transistor is configured to receive a second control signal,
wherein the third terminal of the third transistor is coupled to the data bus, and
wherein the second terminals of the first transistor and the third transistor are coupled to each other.

16. The image sensor as claimed in 15, wherein the at least one additional transistor of each pixel circuit further comprises:
a fourth transistor comprising a first terminal, a second terminal and a third terminal,
wherein the first terminal of the fourth transistor is configured to receive a third control signal,
wherein the third terminal of the fourth transistor is coupled to the respective photodetector, and
wherein the first terminal of the first transistor, the second terminal of the second transistor and the second terminal of the fourth transistor are coupled to each other.

17. The image sensor as claimed in claim 14, wherein the first transistor of each pixel circuit is coupled to at least two photodetectors of the plurality of photodetectors.

18. The image sensor as claimed in claim 17, wherein the at least one additional transistor of each pixel circuit further comprises:
a plurality of fourth transistors, each fourth transistor comprising a first terminal, a second terminal and a third terminal,
wherein the first terminals of the plurality of fourth transistors are configured to receive a third control signal,
wherein the third terminal of a respective fourth transistor of the plurality of fourth transistors is coupled to a respective photodetector of the at least two photodetectors, and
wherein the first terminal of the first transistor, the second terminal of the second transistor and the second terminals of the plurality of fourth transistors are coupled to each other.

19. The image sensor as claimed in claim 1, wherein the first transistor comprises:
a first terminal configured to receive a first control signal;
a second terminal coupled to the respective photodetector; and
a third terminal, wherein, in the sensing mode, the interconnection bus is connectable between the third terminal and the ambient light readout circuit.

20. The image sensor as claimed in claim 19, wherein the at least one additional transistor of each pixel circuit comprises:
a second transistor, a third transistor, a fourth transistor, and a fifth transistor,
wherein each of the second transistor, the third transistor, the fourth transistor and the fifth transistor comprises:
a first terminal, a second terminal, and a third terminal,
wherein the first terminal of the second transistor is configured to receive a second control signal,
wherein the second terminal of the first transistor and the third terminal of the second transistor are coupled to each other,
wherein the first terminal of the third transistor is configured to receive a third control signal,
wherein the first terminal of the fifth transistor is configured to receive a fourth control signal,
wherein the third terminal of the fifth transistor is coupled to a data bus,
wherein the second terminal of the second transistor, the second terminal of the third transistor and the first terminal of the fourth transistor are coupled to each other,
wherein the third terminal of the third transistor and the third terminal of the fourth transistor are configured to receive power, and
wherein the second terminals of the fourth transistor and the fifth transistor are coupled to each other.

21. The image sensor as claimed in claim 1, further comprising at least one control circuit configured to control operation of the plurality of pixel circuits.

22. The image sensor as claimed in claim 1, wherein the interconnection bus comprises a metal.

23. The image sensor as claimed in claim 1, wherein, in the imaging mode, the ambient light readout circuit is disconnected from the plurality of pixel circuits.

24. A display comprising an image sensor as claimed in claim 1.

25. A method of controlling an image sensor, the method comprising:
in an imaging mode of an image sensor, imaging a target with a plurality of photodetectors of the image sensor;
in a sensing mode of the image sensor; detecting ambient light condition with the plurality of photodetectors,
wherein a respective photodetector of the plurality of photodetectors is coupled to a first transistor of a respective pixel circuit of the image sensor, wherein the first transistor is further coupled to at least one additional transistor of the respective pixel circuit,
in the imaging mode, connecting a power bus to the at least one additional transistors of the plurality of pixel circuits to deliver power to the at least one additional transistors, the power bus being separate from the interconnection bus, and
in the sensing mode, connecting an interconnection bus of the image sensor between the first transistors of the pixel circuits and an ambient light readout circuit, such that the interconnection bus carries signals corresponding to the detected ambient light condition from the plurality of photodetectors through the first transistors to the ambient light readout circuit.

26. The method as claimed in claim 25, further comprising, in the imaging mode, supplying power through the interconnection bus to the first transistors of the plurality of pixel circuits.

27. The method as claimed in claim 25, further comprising determining ambient light intensity based on the signals corresponding to the detected ambient light condition.

28. The method as claimed in claim 25, further comprising generating at least one control signal to control operation of the plurality of pixel circuits.

29. The method as claimed in claim 25, further comprising, in the imaging mode, deactivating the ambient light readout circuit.

30. The method as claimed in claim 25, further comprising, in the imaging mode, disconnecting the ambient light readout circuit from the plurality of pixel circuits.
